(19) United States
(12) Patent Application Publication
(10) Pub. No.: US 2023/0126317 A1
(43) Pub. Date: Apr. 27, 2023

(54) SYSTEM AND METHOD FOR PROCESSING VEHICLE EVENT DATA FOR IMPROVED JOURNEY TRACE DETERMINATION

(71) Applicant: Wejo Limited, Manchester (GB)

(72) Inventor: Stephen MILLINGTON, St. Helens (GB)

(21) Appl. No.: 17/941,729

(22) Filed: Sep. 9, 2022

Related U.S. Application Data
(63) Continuation-in-part of application No. 17/509,211, filed on Oct. 25, 2021.

(51) Int. Cl. G01C 21/30

(52) U.S. Cl. CPC G01C 21/30

(57) ABSTRACT

Systems and methods for determining a journey trace based on vehicle event data points, where the method includes: obtaining a road network having a plurality of road segments; and processing a plurality of vehicle event data points of a vehicle to identify a journey trace, each vehicle event data point comprising a longitude, a latitude, and a captured timestamp. The processing includes: identifying one or more point snapping road segment candidates for the vehicle event data points; and determining a journey trace based on identifying the journey trace having a lowest overall penalty among a plurality of candidate journey traces. An overall penalty of the journey trace is determined using a penalty scoring technique where, for each of the one or more vehicle event data points, a fixed snap candidate having a fixed snap penalty is included as one of the one or more point snapping road segment candidates.

### BACKGROUND OF THE DISCLOSURE

The automotive industry is undergoing a radical change unlike anything seen before. Disruption is happening across the whole of the mobility ecosystem. The result is vehicles that are more automated, connected, electrified and shared. This gives rise to an explosion of car generated data. This rich new data asset remains largely untapped.

Vehicle location event data, such as GPS data, is extremely voluminous and can involve 200,000-400,000 records per second. The processing of location event data presents a challenge for conventional systems to provide substantially real-time analysis of the data, especially for individual vehicles. In particular, end user technology can require data packages. What is needed are system platforms and data processing algorithms and processes configured to process and store high-volume data with low latency while still making the high-volume data available for analysis and re-processing.

While there are systems for tracking vehicles, what is needed is virtually real-time and accurate trip and road information from high-volume vehicle data. What is needed are systems and algorithms configured to accurately identify journeys and journey destinations from vehicle movement and route analysis. What is also needed are systems and algorithms configured for more accurate point snapping of vehicle event data points to road segments and/or for a point snapping process that considers whether a vehicle is off-road and/or whether to snap a vehicle event data point to a road segment.

### SUMMARY OF THE DISCLOSURE

The following briefly describes embodiments to provide a basic understanding of some aspects of the innovations described herein. This brief description is not intended as an extensive overview. It is not intended to identify key or critical elements, or to delineate or otherwise narrow the scope. Its purpose is merely to present some concepts in a simplified form as a prelude to the more detailed description that is presented later. An exemplary advantage of the systems and methods described herein is optimized low latency. For example, the systems and methods described in the present disclosure are capable of ingesting and processing vehicle event data for up to at least 600,000 records per second for up to 12 million vehicles.

According to a first embodiment, there is provided a system having an electronic processor and a memory accessible by the processor, wherein the processor is configured to execute program instructions stored on the memory for a method comprising: obtaining a road network having a plurality of road segments; and processing a plurality of vehicle event data points of a vehicle to identify a journey trace, each vehicle event data point comprising a longitude, a latitude, and a captured timestamp. The processing includes: identifying one or more point snapping road segment candidates for one or more of the plurality of vehicle event data points; and determining a journey trace based on identifying the journey trace having a lowest overall penalty among a plurality of candidate journey traces. The journey trace includes an ordered set of a plurality of the road segments defining a path taken by the vehicle. The plurality of the road segments is obtained from the one or more point snapping candidates, and an overall penalty of the journey trace is determined using a penalty scoring technique where, for each of the one or more vehicle event data points, a fixed snap candidate having a fixed snap penalty is included as one of the one or more point snapping road segment candidates.

According to a second embodiment, there is provided a method of determining a journey trace for a plurality of vehicle event data points. The method includes: obtaining a road network having a plurality of road segments; and processing vehicle event data points of a vehicle to identify a journey trace, each vehicle event data point comprising a longitude, a latitude, and a captured timestamp. The processing includes: identifying one or more point snapping road segment candidates for one or more of the vehicle event data points; and determining a journey trace based on identifying the journey trace having a lowest overall penalty among a plurality of candidate journey traces. The journey trace includes an ordered set of a plurality of the road segments defining a path taken by the vehicle. The plurality of the road segments is obtained from the one or more point snapping candidates, and an overall penalty of the journey trace is determined using a penalty scoring technique where, for each of the one or more vehicle event data points, a fixed snap candidate having a fixed snap penalty is included as one of the one or more point snapping road segment candidates.

According to a third embodiment, there is provided a method of determining a journey trace for a plurality of vehicle event data points, wherein the method includes: obtaining a road network having a plurality of road segments; and processing a plurality of vehicle event data points of a vehicle to determine a journey trace, each vehicle event data point comprising a longitude, a latitude, and a captured timestamp. The processing includes: for each of the plurality of vehicle event data points, carrying out a vehicle event data penalty determining process that includes: determining a non-fixed set of point snapping road segment candidates for the vehicle event data point; determining a point snapping penalty for each point snapping road segment candidate of the non-fixed set of point snapping road segment candidates; and determining a fixed snap candidate associated with a fixed snap penalty; and determining the journey trace as the journey trace having a lowest overall penalty determined based on a penalty scoring technique that uses the fixed snap penalty and the point snapping penalty.

### BRIEF DESCRIPTION OF THE DRAWINGS

Non-limiting and non-exhaustive embodiments are described with reference to the various figures unless otherwise specified.

For a better understanding, reference will be made to the following Detailed Description, which is to be read in association with the accompanying drawings, wherein:

FIG. 1A is a system diagram of an environment in which at least one of the various embodiments can be implemented.

FIG. 1B is a cloud computing architecture in accordance with at least one of the various embodiments.

FIG. 1C is a logical architecture for a cloud computing platform in accordance with at least one of the various embodiments.

FIG. 2 shows a logical architecture and flowchart for an Ingress Server system in accordance with at least one of the various embodiments.

FIG. 3 shows a logical architecture and flowchart for a Stream Processing Server system in accordance with at least one of the various embodiments.

FIG. 4A is a logical architecture and flowchart for an Egress Server system in accordance with at least one of the various embodiments.

FIG. 4B is a flowchart for an Egress Server system in accordance with at least one of the various embodiments.

FIG. 4C is a diagram showing a logical layout for a road corridor comprising a plurality of road segments in accordance with at least one of the various embodiments.

FIG. 4D is a diagram showing a logical layout for a road corridor comprising a plurality of road segments in accordance with at least one of the various embodiments.

FIG. 5A is a logical architecture and flowchart for a process for an Analytics Server system in accordance with at least one of the various embodiments.

FIG. 5B is a flowchart for a process for an Analytics Server system in accordance with at least one of the various embodiments.

FIG. 5C is a logical graph for a process for an Analytics Server system in accordance with at least one of the various embodiments.

FIG. 5D is a logical graph for a process for an Analytics Server system in accordance with at least one of the various embodiments.

FIG. 5E is a logical architecture and flowchart for a process for an Analytics Server system in accordance with at least one of the various embodiments.

FIG. 6 is a logical architecture and flowchart for a process for a Portal Server system in accordance with at least one of the various embodiments in accordance with at least one of the various embodiments.

FIG. 7 is a flow chart showing a data quality pipeline of data processing checks for the system in accordance with at least one of the various embodiments.

FIG. 8 is a flow chart and interface diagram for egressing a feed to an interface in accordance with at least one of the various embodiments.

FIG. 9A is an embodiment of a multigraph of vehicle event movement filtered to identify road nodes.

FIG. 9B is an embodiment of a multigraph of tower nodes and road segments.

FIG. 10 shows an example of misapplied road snapping.

FIG. 11A shows a mapping interface of intersections.

FIG. 11B shows a mapping interface of turn ratio percentages for an intersection.

FIG. 11C shows a mapping interface of turn ratio percentages a plurality of intersections in a geographical area including intersections.

FIG. 11D shows graph of turn ratios by time.

FIG. 11E shows a graph of turn ratios by type.

FIG. 12 shows a flowchart of an embodiment of a method of determining a journey trace for a vehicle.

FIG. 13 shows a flowchart of another embodiment of a method of determining a journey trace for a vehicle.

### DETAILED DESCRIPTION OF THE EMBODIMENTS

Various embodiments now will be described more fully hereinafter with reference to the accompanying drawings, which form a part hereof, and which show, by way of illustration, specific embodiments by which the innovations described herein can be practiced. The embodiments can, however, be embodied in many different forms and should not be construed as limited to the embodiments set forth herein. Rather, these embodiments are provided so that this disclosure will be thorough and complete, and will fully convey the scope of the embodiments to those skilled in the art. Among other things, the various embodiments can be methods, systems, media, or devices. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” or “in an embodiment” as used herein does not necessarily refer to the same embodiment or a single embodiment, though it can. Furthermore, the phrase “in another embodiment” as used herein does not necessarily refer to a different embodiment, although it can. Thus, as described below, various embodiments can be readily combined, without departing from the scope or spirit of the present disclosure.

In addition, as used herein, the term “or” is an inclusive “or” operator, and is equivalent to the term “and/or” unless the context clearly dictates otherwise. The term “based on” is not exclusive and allows for being based on additional factors not described, unless the context clearly dictates otherwise. In addition, throughout the specification, the meaning of “a” “an” and “the” include plural references. The meaning of “in” includes “in” and “on.”

As used herein, the term “Host” can refer to an individual person, partnership, organization, or corporate entity that can own or operate one or more digital media properties (e.g., web sites, mobile applications, or the like). Hosts can arrange digital media properties to use hyper-local targeting by arranging the property to integrate with widget controllers or servers.

The following briefly describes various embodiments of a system, method, and computer program product for processing vehicle event data.

As used herein, a journey can include any trip, run, or travel to a destination.

### Illustrative Logical System Architecture and System Flows

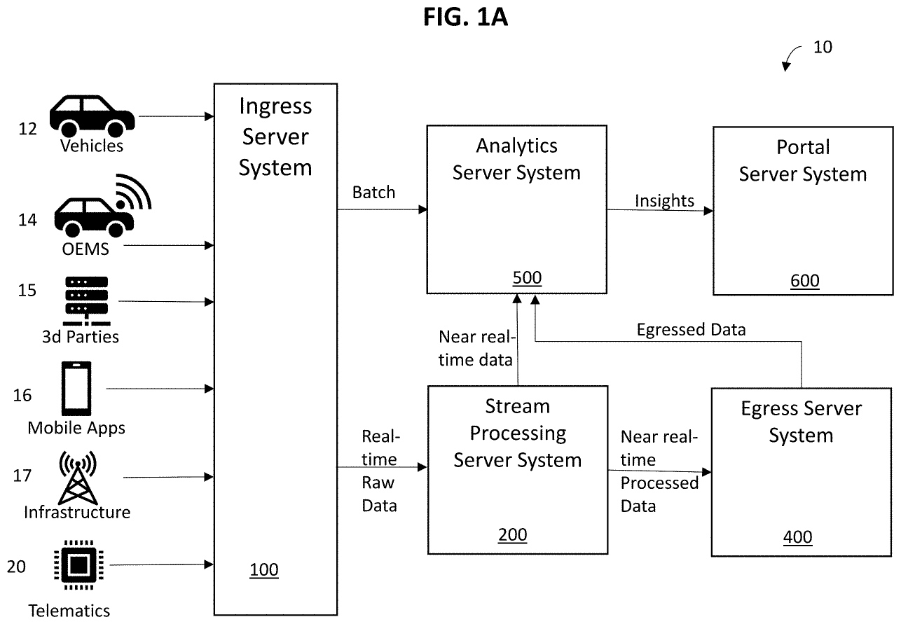

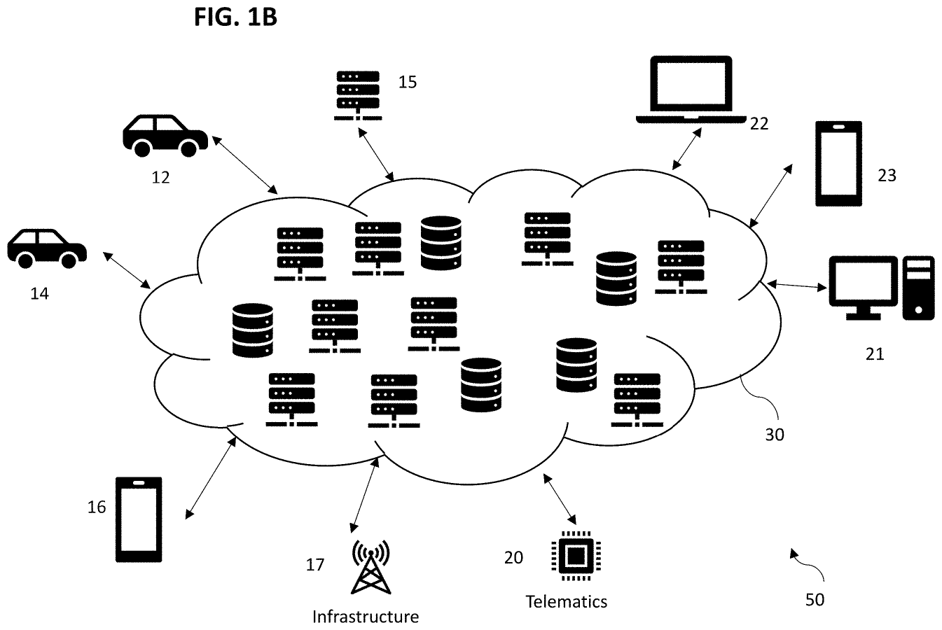

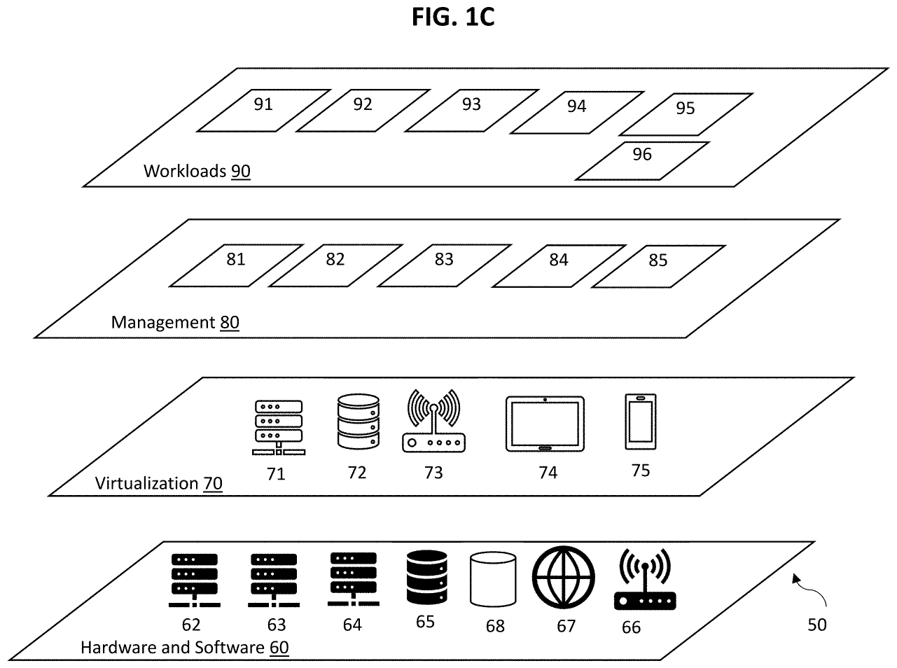

FIG. 1A is a logical architecture of system 10 for geolocation event processing and analytics in accordance with at least one embodiment. In at least one embodiment, Ingress Server system 100 can be arranged to be in communication with Stream Processing Server system 200 and Analytics Server system 500. The Stream Processing Server system 200 can be arranged to be in communication with Egress Server system 400 and Analytics Server system 500.

The Egress Server system 400 can be configured to be in communication with and provide data output to data consumers. The Egress Server system 400 can also be configured to be in communication with the Stream Processing Server 200.

The Analytics Server system 500 is configured to be in communication with and accept data from the Ingress Server system 100, the Stream Processing Server system 200, and the Egress Server system 400. The Analytics Server system 500 is configured to be in communication with and output data to a Portal Server system 600.

In at least one embodiment, Ingress Server system 100, Stream Processing Server system 200, Egress Server system 400, Analytics Server system 500, and Portal Server system 600 can each be one or more computers or servers. In at least one embodiment, one or more of Ingress Server system 100, Stream Processing Server system 200, Egress Server system 400, Analytics Server system 500, and Portal Server system 600 can be configured to operate on a single computer, for example a network server computer, or across multiple computers. For example, in at least one embodiment, the system 10 can be configured to run on a web services platform host such as Amazon Web Services (AWS) or Microsoft Azure. In an exemplary embodiment, the system 10 is configured on an AWS platform employing a Spark Streaming server, which can be configured to perform the data processing as described herein. In an embodiment, the system 10 can be configured to employ a high throughput messaging server, for example, Apache Kafka.

In at least one embodiment, Ingress Server system 100, Stream Processing Server system 200, Egress Server system 400, Analytics Server system 500, and Portal Server system 600 can be arranged to integrate and/or communicate using API's or other communication interfaces provided by the services.

In at least one embodiment, Ingress Server system 100, Stream Processing Server system 200, Egress Server system 400, Analytics Server system 500, and Portal Server system 600 can be hosted on Hosting Servers.

In at least one embodiment, Ingress Server system 100, Stream Processing Server system 200, Egress Server system 400, Analytics Server system 500, and Portal Server system 600 can be arranged to communicate directly or indirectly over a network to the client computers using one or more direct network paths including Wide Access Networks (WAN) or Local Access Networks (LAN).

As described herein, embodiments of the system 10, processes and algorithms can be configured to run on a web services platform host such as Amazon Web Services (AWS)® or Microsoft Azure®. A cloud computing architecture is configured for convenient, on-demand network access to a shared pool of configurable computing resources (e.g. networks, network bandwidth, servers, processing, memory, storage, applications, virtual machines, and services). A cloud computer platform can be configured to allow a platform provider to unilaterally provision computing capabilities, such as server time and network storage, as needed automatically without requiring human interaction with the service's provider. Further, cloud computing is available over a network and accessed through standard mechanisms that promote use by heterogeneous thin or thick client platforms (e.g., mobile phones, laptops, and PDAs). In a cloud computing architecture, a platform's computing resources can be pooled to serve multiple consumers, partners or other third party users using a multi-tenant model, with different physical and virtual resources dynamically assigned and reassigned according to demand. A cloud computing architecture is also configured such that platform resources can be rapidly and elastically provisioned, in some cases automatically, to quickly scale out and rapidly released to quickly scale in.

Cloud computing systems can be configured with systems that automatically control and optimize resource use by leveraging a metering capability at some level of abstraction appropriate to the type of service (e.g., storage, processing, bandwidth, and active user accounts). Resource usage can be monitored, controlled, and reported. As described herein, in embodiments, the system 10 is advantageously configured by the platform provider with innovative algorithms and database structures configured for low-latency.

A cloud computing architecture includes a number of service and platform configurations.

A Software as a Service (SaaS) is configured to allow a platform provider to use the provider's applications running on a cloud infrastructure. The applications are accessible from various client devices through a thin client interface such as a web browser (e.g., web-based e-mail). The consumer typically does not manage or control the underlying cloud infrastructure including network, servers, operating systems, storage, or even individual application capabilities, with the possible exception of limited user-specific application configuration settings.

A Platform as a Service (PaaS) is configured to allow a platform provider to deploy onto the cloud infrastructure consumer-created or acquired applications created using programming languages and tools supported by the provider. The consumer does not manage or control the underlying cloud infrastructure including networks, servers, operating systems, or storage, but can a have control over the deployed applications and possibly application hosting environment configurations.

An Infrastructure as a Service (IaaS) is configured to allow a platform provider to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

A cloud computing architecture can be provided as a private cloud computing architecture, a community cloud computing architecture, or a public cloud computing architecture. A cloud computing architecture can also be configured as a hybrid cloud computing architecture comprising two or more clouds platforms (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 1B, an illustrative cloud computing environment 50 is depicted. As shown, cloud computing environment 50 comprises one or more cloud computing nodes 30 with which local computing devices used by cloud consumers, such as, for example, personal digital assistant (PDA) or cellular telephone 23, desktop computer 21, laptop computer 22, and event such as OEM vehicle sensor data source 14, application data source 16, telematics data source 20, wireless infrastructure data source 17, and third party data source 15 and/or automobile computer systems such as vehicle data source 12. Nodes 30 can communicate with one another. They can be grouped (not shown) physically or virtually, in one or more networks, such as private, community, public, or hybrid clouds as described herein, or a combination thereof. The cloud computing environment 50 is configured to offer infrastructure, platforms and/or software as services for which a cloud consumer does not need to maintain resources on a local computing device. It is understood that the types of computing devices shown in FIG. 1B are intended to be illustrative only and that computing nodes 30 and cloud computing environment 50 can communicate with any type of computerized device over any type of network and/or network addressable connection (e.g., using a web browser).

Referring now to FIG. 1C, a set of functional abstraction layers provided by cloud computing environment 50 (FIG. 1B) is shown. The components, layers, and functions shown in FIG. 1C are illustrative, and embodiments as described herein are not limited thereto. As depicted, the following layers and corresponding functions are provided:

A hardware and software layer 60 can comprise hardware and software components. Examples of hardware components include, for example: mainframes 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management so that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment can be utilized. Examples of workloads and functions that can be provided from this layer include mapping and navigation 91; ingress processing 92, stream processing 93; portal dashboard delivery 94—same number; data analytics processing 95; and egress and data delivery 96.

Although this disclosure describes embodiments on a cloud computing platform, implementation of embodiments as described herein are not limited to a cloud computing environment.

One of ordinary skill in the art will appreciate that the architecture of system 10 is a non-limiting example that is illustrative of at least a portion of an embodiment. As such, more or less components can be employed and/or arranged differently without departing from the scope of the innovations described herein.

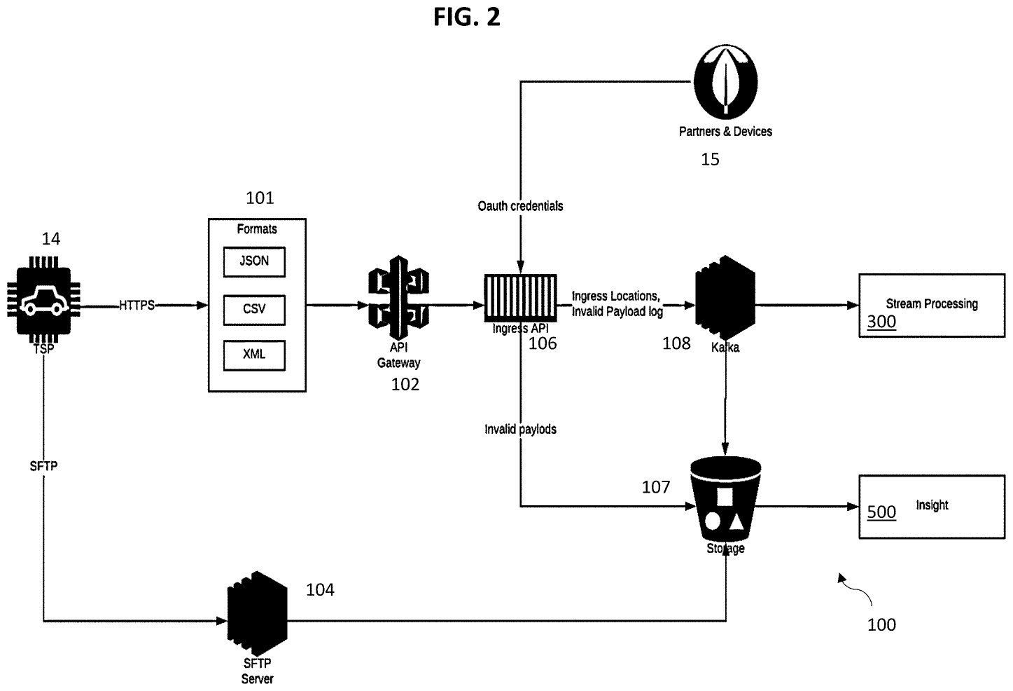

Referring to FIG. 2, a logical architecture for an Ingress Server system 100 for ingesting data and data throughput in accordance with at least one embodiment is shown. In at least one embodiment, events from one or more event sources can be determined. In an embodiment, as shown in FIGS. 1A and 1i, event sources can include vehicle sensor data source 12, OEM vehicle sensor data source 14, application data source 16, telematics data source 20, wireless infrastructure data source 17, and third party data source 15 or the like. In at least one embodiment, the determined events can correspond to location data, vehicle sensor data, various user interactions, display operations, impressions, or the like, that can be managed by downstream components of the system, such as Stream Processing Server system 200 and Analytics Server system 500. In at least one embodiment, Ingress Server system 100 can ingress more or fewer event sources than shown in FIGS. 1A-2.

In at least one embodiment, events that can be received and/or determined from one or more event sources includes vehicle event data from one or more data sources, for example GPS devices, or location data tables provided by third party data source 15, such as OEM vehicle sensor data source 14. Vehicle event data can be ingested in database formats, for example, JSON, CSV, and XML. The vehicle event data can be ingested via APIs or other communication interfaces provided by the services and/or the Ingress Server system 100. For example, Ingress Server system 100 can offer an API Gateway 102 interface that integrates with an Ingress Server API 106 that enables Ingress Server system 100 to determine various events that can be associated with databases provided by the vehicle event source 14. An exemplary API gateway can include, for example AWS API Gateway. An exemplary hosting platform for an Ingress Server system 100 system can include Kubernetes and Docker, although other platforms and network computer configurations can be employed as well.

In at least one embodiment, the Ingress Server system 100 includes a Server 104 configured to accept raw data, for example, a Secure File Transfer Protocol Server (SFTP), an API, or other data inputs can be configured accept vehicle event data. The Ingress Server system 100 can be configured to store the raw data in data store 107 for further analysis, for example, by an Analytics Server system 500. Event data can include Ignition on, time stamp (T1 . . . TN), Ignition off, interesting event data, latitude and longitude, and Vehicle Information Number (VIN) information. Exemplary event data can include Vehicle Movement data from sources as known in the art, for example either from vehicles themselves (e.g. via GPS, API) or tables of location data provided from third party data sources 15.

In at least one embodiment, the Ingress Server system 100 is configured to clean and validate data. For example, the Ingress Server 100 can be configured include Ingress API 106 that can validate the ingested event and location data and pass the validated location data to a server queue 108, for example, an Apache Kafka queue, which is then outputted to the Stream Processing Server 200. The server 108 can be configured to output the validated ingressed location data to the data store 107 as well. The Ingress Server can also be configured pass invalid data to a data store 107. For example, invalid payloads can be stored in data store 107. Exemplary invalid data can include, for example, data with bad fields or unrecognized fields, or identical events.

In an embodiment, the system 10 is configured to detect and map vehicle locations with enhanced accuracy. In order to gather useful aggregates about the road network, for example expected traffic volumes and speeds across the daily/weekly cycle, the system 10 can be configured to determine how vehicles are moving through a given road network. As noted herein, a naïve approach of associating or “snapping” each data point with a nearest section of a road can fail because vehicle GPS data has an inherent degree of error due to various known physical effects. Further, a road network often approaches and crosses itself in complicated geometries leading to locations with multiple road snapping candidates.

In an embodiment, the system 10 can be configured to include a base map given as a collection of line segments for road segments. The system 10 includes, for each line segment, geometrical information regarding the line segment's relation to its nearest neighbors. For each line segment, statistical information regarding expected traffic volumes and speeds is generated from an initial iteration of the process. As shown above, vehicle movement event data comprises longitude, latitude, heading, speed and time-of-day or other time data.

In an embodiment, the system 10 is configured to take a collection of line segments, which corresponds to road segments, and create an R-Tree index over the collection of line segments. R-trees are tree data structures used for spatial access methods, i.e., for indexing multi-dimensional information such as geographical coordinates, rectangles or polygons. The R-tree is configured to store spatial objects as bounding box polygons to represent, inter alia, road segments. The R-Tree is first used to find road segment candidates within a prescribed distance of a coordinate in order to snap a data point. The candidates are then further examined using a refined metric that considers event data, such as the heading, to select a road segment, which is most likely based on all known information. Event data such as speed and/or time-of-day can also be employed to select a road segment.

In an embodiment, the system 10 can also be configured to penalize road segments that are not aligned in the direction of travel of the given data point by adding a fixed or predetermined penalty to the actual distance between the point and the road segment. This makes line segments that do not align with the direction of travel to appear further away and therefore less likely to be selected as the correct one. In cases where there is still some question over which segment is the best fit, the system 10 can be configured to weigh additional information regarding the expected speed of the given point and additional geometrical considerations before selection takes place.

The system 10 is configured to predefine distances between bounding box road segments, for example using an R-tree as described above. For precalculated distances for the road segments, the system 10 can be configured to select a nearest neighbor for a closest distance. In an embodiment, the system 10 can also be configured to add a penalty to determine if the road segment with the closest distance is the correct road segment for the vehicle.

The system 10 is configured to identify a distance between a point (lat/long) and a road segment (line segment). An Item Distance artery implementation allows any two points in distance to be identified to a road segment. In an embodiment, the system can also be configured to implement a penalty for a heading in order to override choosing a road segment based on a naïve or default selection of a closest point from the lat/long data point. As noted above, a road segment can be defined as a bounding box or line segment.

For example, the system 10 can be configured to allow an angular range of deviation between a car heading and road heading to determine whether to apply a penalty in selecting the road segment. For example, where the deviation is small, no penalty is applied, as the car heading and the road heading are highly likely to be accurate when the angle of deviation is small. Thus, the system 10 can be configured to choose a smallest angle to identify a segment heading. However, if the smallest angle is less than a predetermined angle, for example in the range of 10-40 degrees out of 360 degrees, the system 10 can be configured to select that road segment or preferentially weight that road segment for selection.

In an embodiment, other event data can be employed to weight the selection of the penalty, for example the speed of vehicle (mph). For instance, when a vehicle speed indicates a high speed and/or a high angle of deviation, the penalty can be applied. If the road heading is more than 30 degrees from the car heading, and the speed is higher than the a given speed threshold, it is highly likely that the road segment is not accurate, and so the penalty should be applied. On the other hand, if the angle of deviation between the car heading and the road heading is small and the speed is high, it is highly likely that the vehicle is indeed moving in the proper direction at that speed.

Accordingly, in an embodiment, an angle differential, for example over 30 degrees and under 180 degrees for a heading, can be employed to determine a “one way” or “wrong way” penalty using directional information from associated map data for a road segment. For example, if a closest point between the two points for selecting a road segment results in angle differential between 30 degrees to 150 degrees, and that angle would place the vehicle on the wrong direction for the segment, the system can be configured to apply a wrong way penalty.

An exemplary penalty algorithm is as follows:

```
class CarCoords(val longitude:Double, val latitude:Double, val heading: Double, val speed:
Double) {
}
class RoadSegmentDistance(wrongWayPenalty: Double) extends ItemDistance with Serializable
{
    def distance(i_rs: ItemBoundable, i_coords: ItemBoundable) :Double = {
      val coords = i_coords.getItem( ).asInstanceOf[CarCoords]
      val rs = i_rs.getItem( ).asInstanceOf[RoadSegment]
      snap_result(rs, coords, false)._6
    }
    def snap_result(rs: RoadSegment, coords: CarCoords, use_haversine:Boolean) = {
      val pt = new Coordinate(coords.longitude, coords.latitude)
      val lln = new LocationIndexedLine(rs.line)
      val projected_linearlocation = lln.project(pt)
    val segment = projected_linearlocation.getSegment(rs.line)
    val snappedpt = lln.extractPoint(projected_linearlocation)
      val segment_heading = (450 − math.toDegrees(segment.angle)) % 360
      val angle_diff = if (math.abs(segment_heading − coords.heading) < 180)
math.abs(segment heading − coords.heading) else 360 − math.abs(segment_heading −
coords, heading)
    val wrong_way = if (rs.oneway != 0 && angle_diff > 30) 1
    else if (rs.oneway == 0 && angle_diff > 30 && angle_diff < 150) 1
    else 0
      val distance = if (!use_haversine) pt.distance(snappedpt) else {
      1000 * EARTH_EQUATORIAL_RADIUS_KM *
        distHaversineRAD(
          DEGREES_TO_RADIANS * pt.y,
          DEGREES_TO_RADIANS * pt.x,
          DEGREES_TO_RADIANS * snappedpt.y,
          DEGREES_TO_RADIANS * snappedpt.x)
    }
      val penalised_distance = wrongWayPenalty * wrong_way + distance
      (rs.id, snappedpt.x, snappedpt.y, distance, segment_heading, penalised_distance, rs.oneway
!= 0, rs.road_type)
    }
  }
```

The output from the algorithm comprises: a road segment chosen as the best match; a new (longitude, latitude) pair that represents the original point snapped to the chosen line segment; and the error or distance between the original point and the snapped point. As noted above, the system 10 is configured to apply a penalty to obtain the most likely road segment.

In an embodiment, the algorithm can also include a measure of confidence in the chosen road segment based on the number of other potential matches that closely match the criteria for selection. For example, a weight could comprise a road knowledge weight, for example, time-of-day, miles-per-hour and/or road type weight. For instance, a road knowledge weight might include a highway or residential road weight. Thus, if a road segment is known to be a residential segment, a selection could be weighted to penalize choosing a nearest highway segment when a vehicle is identified as going 30 miles per hour.

The Ingress Server 100 can be configured to output the stored invalid data or allow stored data to be pulled to the Analysis Server 500 from the data store 107 for analysis, for example, to improve system performance. For example, the Analysis Server 500 can be configured with diagnostic machine learning configured to perform analysis on databases of invalid data with unrecognized fields to newly identify and label fields for validated processing. The Ingress Server 100 can also be configured to pass stored ingressed location data for processing by the Analytics server 500, for example, for Journey analysis as described herein.

In an embodiment, the Ingress Server 100 is configured to process event data to derive vehicle movement data, for example speed, duration, and acceleration. For example, in an embodiment, a snapshot is taken on the event database every x number of seconds (e.g. 3 seconds). Lat/long data and time data can then be processed to derive vehicle tracking data, such as speed and acceleration, using vehicle position and time.

In an embodiment, the Ingress Server system 100 is configured to accept data from devices and third party platforms. The Ingress Server API 106 can be configured to authenticate devices and partner or third-party platforms and platform hosts to the system 10.

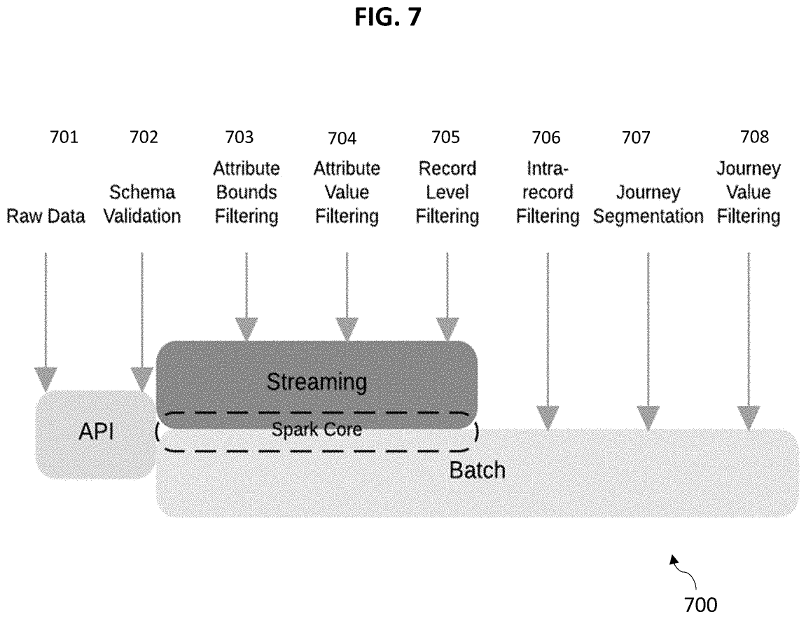

Accordingly, in an embodiment, the Ingress Server system 100 is configured to receive raw data and perform data quality checks for raw data and schema evaluation. Ingesting and validating raw data is the start of a data quality pipeline of quality checks for the system as shown in FIG. 7 at block 701. Table 1 shows an example of raw data that can be received into the system 10.

TABLE 1

| | Attribute | Type | Nullable | Description |
|---|---|---|---|---|
| Raw | partner_id | Integer | No | Identifier for ingress partner |
| Data. | device_id | String | Yes | 4-9 characters long |
| | captured_ | String | No | Time of an event, expressed in |
| | timestamp | | | local time with UTC offset |
| | received_ | String | No | Time event was received by |
| | timestamp | | | Ingress Server, UTC |
| | longitude, | Double | No | WGS84 coordinates of an event |
| | latitude | | | |
| | speed | Float | No | Vehicle speed in kilometers per |
| | | | | hour recorded at the time of an |
| | | | | event |
| | additional | Map | No | Map of string key-value pairs to |
| | | | | express data attributes unique to |
| | | | | each ingress |
| | journey_id | String | No | An identifier for a journey and the |
| | | | | associated events within it |
| | heading | Integer | Yes | Clockwise orientation of vehicle, |
| | | | | 0 equals North |
| | altitude | Integer | Yes | Elevation of vehicle as reported by |
| | | | | GPS |
| | squish_vin | String | Yes | Encoded representation of vehicle |
| | | | | make/model characteristics |
| | ignition_ | String | Yes | Indicator of whether vehicle is |
| | status | | | under power |

In another embodiment, vehicle event data from an ingress source can include less information. For example, as shown in Table 2, the raw vehicle event data can comprise a limited number of attributes, for example, location data (longitude and latitude) and time data (timestamps).

TABLE 2

| | Attribute | Type | Nullable | Description |
|---|---|---|---|---|
| Raw | captured_ | String | No | Time of an event, expressed |
| Data. | timestamp | | | in local time with UTC |
| | | | | offset |
| | received_ | String | No | Time event was received by |
| | timestamp | | | Ingress Server, UTC |
| | longitude, | Double | No | WGS84 coordinates of |
| | latitude | | | an event |

An exemplary advantage of embodiments of the present disclosure is that information that is absent can be derived from innovative algorithms as described herein. For example, vehicle event data may not include a journey identification, or may have a journey identification that is inaccurate. Accordingly, the system 10 can be configured to derive additional vehicle event attribute data when the initially ingressed data has limited attributes. For example, the system 10 can be configured to identify a specific vehicle for ingressed vehicle event data and append a Vehicle ID or Device ID. The system 10 can thereby trace vehicle movement—including starts and stops, speed, heading, acceleration, and other attributes using, for example, only location and timestamp data associated with a Vehicle ID or Device ID.

In an embodiment, at block 702, data received can conform to externally defined schema, for example, Avro or JSON. The data can be transformed into internal schema and validated. In an embodiment, event data can be validated against an agreed schema definition before being passed on to the messaging system for downstream processing by the data quality pipeline. For example, an Apache Avro schema definition can be employed before passing the validated data on to an Apache Kafka messaging system. In another embodiment, the raw movement and event data can also be processed by a client node cluster configuration, where each client is a consumer or producer, and clusters within an instance can replicate data amongst themselves.

For example, the Ingress server system 100 can be configured with a Pulsar Client connected to an Apache Pulsar end point for a Pulsar cluster. In an embodiment, the Apache Pulsar end point keeps track of the last data read, allowing an Apache Pulsar Client to connect at any time to pick up from the last data read. In Pulsar, a “standard” consumer interface involves using “consumer” clients to listen on topics, process incoming messages, and finally acknowledge those messages when the messages have been processed. Whenever a client connects to a topic, the client automatically begins reading from the earliest unacknowledged message onward because the topic's cursor is automatically managed by a Pulsar Broker module. However, a client reader interface for the client enables the client application to manage topic cursors in a bespoke manner. For example, a Pulsar client reader can be configured to connect to a topic to specify which message the reader begins reading from when it connects to a topic. When connecting to a topic, the reader interface enables the client to begin with the earliest available message in the topic or the latest available message in the topic. The client reader can also be configured to begin at some other message between the earliest message and the latest message, for example by using a message ID to fetch messages from a persistent data store or cache.

As noted above, in at least one embodiment, the Ingress Server system 100 is configured to clean and validate data. For example, the Ingress Server system 100 can be configured include an Ingress Server API 106 that can validate the ingested vehicle event and location data and pass the validated location data to a server queue 108, for example, an Apache Kafka queue, which is then outputted to the Stream Processing Server system 200. Server 104 can be configured to output the validated ingressed location data to the data store 107 as well. The Ingress Server system 100 can also be configured to pass invalid data to a data store 107.

The map database can be, for example, a point of interest database or other map database, including public or proprietary map databases. Exemplary map databases can include extant street map data such as Geofabric for local street maps, or World Map Database. The system can be further configured to egress the data to external mapping interfaces, navigation interfaces, traffic interfaces, and connected car interfaces as described herein.

The Ingress Server system 100 can be configured to output the stored invalid data or allow stored data to be pulled to the Analysis Server system 500 from the data store 107 for analysis, for example, to improve system performance. For example, the Analysis Server system 500 can be configured with diagnostic machine learning configured to perform analysis on databases of invalid data with unrecognized fields to newly identify and label fields for validated processing. The Ingress Server system 100 can also be configured to pass stored ingressed location data for processing by the Analytics Server system 500.

As described herein, the system 10 is configured to process data in both a streaming and a batch context. In the streaming context, low latency is more important than completeness, i.e. old data need not be processed, and in fact, processing old data can have a detrimental effect as it may hold up the processing of other, more recent data. In the batch context, completeness of data is more important than low latency. Accordingly, to facilitate the processing of data in these two contexts, in an embodiment, the system 10 can default to a streaming connection that ingresses all data as soon as it is available but can also be configured to skip old data. A batch processor 501 can be configured to fill in any gaps left by the streaming processor due to old data.

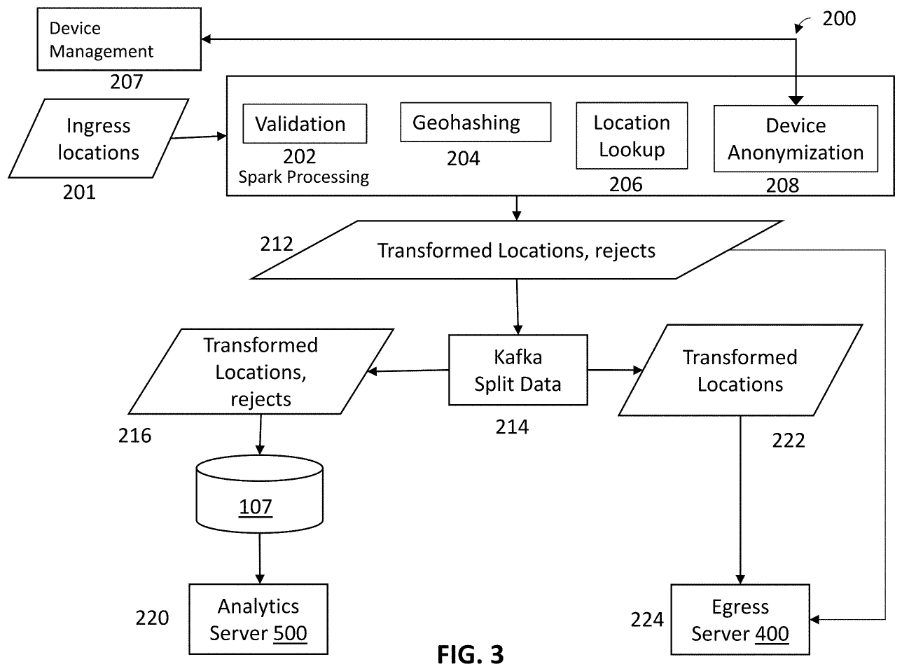

FIG. 3 is a logical architecture for a Stream Processing Server system 200 for data throughput and analysis in accordance with at least one embodiment. Stream processing as described herein results in system processing improvements, including improvements in throughput in linear scaling of at least 200 k to 600 k records per second. Improvement further includes end-to-end system processing of 20 seconds, with further improvements to system latency being ongoing. In at least one embodiment, the system 10 can be configured to employ a server for micro-batch processing. For example, as described herein, in at least one embodiment, the Stream Processing Server system 200 can be configured to run on a web services platform host such as AWS employing a Spark Streaming server and a high throughput messaging server such as Apache Kafka. In an embodiment, the Stream Processing Server system 200 can include Device Management Server 207, for example, AWS Ignite, which can be configured input processed data from the data processing server. The Device Management Server 207 can be configured to use anonymized data for individual vehicle data analysis, which can be offered or interfaced externally. The system 10 can be configured to output data in real time, as well as to store data in one or more data stores for future analysis. For example, the Stream Processing Server system 200 can be configured to output real time data via an interface, for example Apache Kafka, to the Egress Server system 400. The Stream Processing Server system 200 can also be configured to store both real-time and batch data in the data store 107. The data in the data store 107 can be accessed or provided to the Insight Server system 500 for further analysis.

In at least one embodiment, event information can be stored in one or more data stores 107, for later processing and/or analysis. Likewise, in at least one embodiment, event data and information can be processed as it is determined or received. Also, event payload and process information can be stored in data stores, such as data store 107, for use as historical information and/or comparison information and for further processing.

In at least one embodiment, the Stream Processing Server system 200 is configured to perform vehicle event data processing.

FIG. 3 illustrates a logical architecture and overview flowchart for a Steam Processing Server system 200 in accordance with at least one embodiment. At block 202, the Stream Processing Server system 200 performs validation of location event data from ingressed locations 201. Data that is not properly formatted, is duplicated, or is not recognized is filtered out. Exemplary invalid data can include, for example, data with bad fields, unrecognized fields, or identical events (duplicates) or engine on/engine off data points occurring at the same place and time. The validation also includes a latency check, which discards event data that is older than a predetermined time period, for example, 7 seconds. In an embodiment, other latency filters can be employed, for example between 4 and 15 seconds.

In an embodiment, as shown at block 703 of FIG. 7, the Stream Processing Server system 200 is configured perform Attribute Bounds Filtering. Attribute Bounds Filtering checks to ensure event data attributes are within predefined bounds for the data that is meaningful for the data. For example, a heading attribute is defined as a circle (0→359). A squish-vin is a 9-10 character VIN. Examples include data that is predefined by a data provider or set by a standard. Data values not within these bounds indicate the data is inherently faulty for the Attribute. Non-conforming data can be checked and filtered out. An example of Attribute Bounds Filtering is given in Table 3.

TABLE 3

| | | | | | | | Data |
|---|---|---|---|---|---|---|---|
| | | | | | | Data | Points |
| | | | | Defined | | Points | Flagged |
| | | Attribute | Units | by | Bounds | Flagged | (%) |
| Attribute | Attributes | device_id | String | Externally | N/A | 27 | 0.00171% |
| Bounds | contain | | | | | | |
| Filtering | only | longitude, | Double | Internally | to spec | 586 | 586 |
| Values | values | latitude | | | | | |
| within | within | heading | Integer | Externally | 0 → 359 | 94 | 0.00004% |
| meaningful | externally | | | | | | |
| range. | predefined | squish_vin | String | Externally | 9-10 | 0 | 0% |
| | boundaries. | | | | characters | | |

In an embodiment, at block 704 the system 10 is configured to perform Attribute Value Filtering. Attribute Value Filtering checks to ensure attribute values are internally set or bespoke defined ranges. For example, while a date of 1970 can pass an Attribute Bounds Filter check for a date Attribute of the event, the date is not a sensible value for vehicle tracking data. Accordingly, Attribute Value Filtering is configured to filter data older than a predefined time, for example 6 weeks or older, which can be checked and filtered. An example Attribute Bounds Filtering is given in Table 4.

TABLE 4

| | | | | | | | Data |
|---|---|---|---|---|---|---|---|
| | | | | | | Data | Points |
| | | | | Defined | | Points | Flagged |
| | | Attribute | Units | by | Bounds | Flagged | (%) |
| Attributes | Attributes | captured_ | Timestamp | | <6 | | 64296 |
| Value | contain | timestamp | | | weeks | | |
| Filtering | only | | | | ago | | |
| Values | values | received_ | Timestamp | | >now | | 0 |
| within | within | timestamp | | | | | |
| reasonable | internally | longitude, | degrees | Internally | bounding | | 0 |
| range. | defined | latitude | | | box | | |
| | boundaries. | Speed | kph | Internally | 0 → 360 | | 0 |
| | | Altitude | metres | Internally | −1000 → 10000 | | |

At block 705, the system 10 can perform further validation on Attributes in a record to confirm that relationships between attributes of record data points are coherent. For example, a non-zero trip start event does not make logical sense for a Journey determination as described herein. Accordingly, as shown in Table 5, the system 10 can be configured to filter non-zero speed events recorded for the same Attributes for a captured timestamp and a received timestamp for a location as “TripStart” or Journey ignition on start event.

TABLE 5

| | | | | Data |
|---|---|---|---|---|
| Record- | | | Data | Points |
| Level | | | Points | Flagged |
| Filtering | Attributes | Conditions | Flagged | (%) |
| Row | speed, | speed > 0 AND | 439 | 0.0004% |
| contents | ignition_ | ignition_status IN | | |
| have | status | (‘KEY_OFF’, | | |
| semantic | | ‘KEY_ON’) | | |
| meaning. | | | | |
| | captured_ | received_timestamp < | 41 | 0.00004% |
| | timestamp, | captured_timestamp | | |
| | received_ | | | |
| | timestamp | | | |

Returning to FIG. 2, at block 204, in at least one embodiment, the Stream Processing Server 200 performs geohashing of the location event data. While alternatives to geohashing are available, such as an H3 algorithm as employed by Uber™, or a S2 algorithm as employed by Google™, it was found that geohashing provided exemplary improvements to the system 10, for example improvements to system latency and throughput. Geohashing also provided for database improvements in system 10 accuracy and vehicle detection. For example, employing a geohash to 9 characters of precision can allow a vehicle to be uniquely associated the geohash. Such precision can be employed in Journey determination algorithms as described herein. In at least one embodiment, the location data in the event data is encoded to a proximity, the encoding comprising geohashing latitude and longitude for each event to a proximity for each event. The event data comprises time, position (lat/long), and event of interest data. Event of interest data can include harsh brake and harsh acceleration. For example, a harsh brake can be defined as a deceleration in a predetermined period of time (e.g. 40-0 in x seconds), and a harsh acceleration is defined as an acceleration in a predetermined period of time (e.g. 40-80 mph in x seconds). Event of interest data can be correlated and processed for employment in other algorithms. For example, a cluster of harsh brakes mapped in location to a spatiotemporal cluster can be employed as a congestion detection algorithm.

The geohashing algorithm encodes latitude and longitude (lat/long) data from event data to a short string of n characters. In an embodiment, the geohashed lat/long data is geohashed to a shape. For example, in an embodiment, the lat/long data can be geohashed to a rectangle whose edges are proportional to the characters in the string. In an embodiment, the geohash can be encoded from to 4 to 9 characters.

A number of advantages flow from employing geohashed event data as described herein. For example, in a database, data indexed by geohash will have all points for a given rectangular area in contiguous slices, where the number of slices is determined by the geohash precision of encoding. This improves the database by allowing queries on a single index, which is much easier or faster than multiple-index queries. The geohash index structure is also useful for streamlined proximity searching, as the closest points are often among the closest geohashes.

At block 206, in at least one embodiment, the Stream Processing Server system 200 performs a location lookup. As noted above, in an embodiment, the system 10 can be configured to encode the geohash to identify a defined geographical area, for example, a country, a state, or a zip code. The system 10 can geohash the lat/long to a rectangle whose edges are proportional to the characters in the string.

For example, in an embodiment, the geohashing can be configured to encode the geohash to 5 characters, and the system 10 can be configured to identify a state to the 5-character geohashed location. For example, the geohash encoded to 5 slices or characters of precision is accurate to +/−2.5 kilometers, which is sufficient to identify a state. A geohash to 6 characters can be used to identify the geohashed location to a zip code, as it is accurate to +/−0.61 kilometers. A geohash to 4 characters can be used to identify a country. In an embodiment, the system 10 can be configured to encode the geohash to uniquely identify a vehicle with the geohashed location. In an embodiment, the system 10 can be configured to encode the geohash to 9 characters to uniquely identify a vehicle.

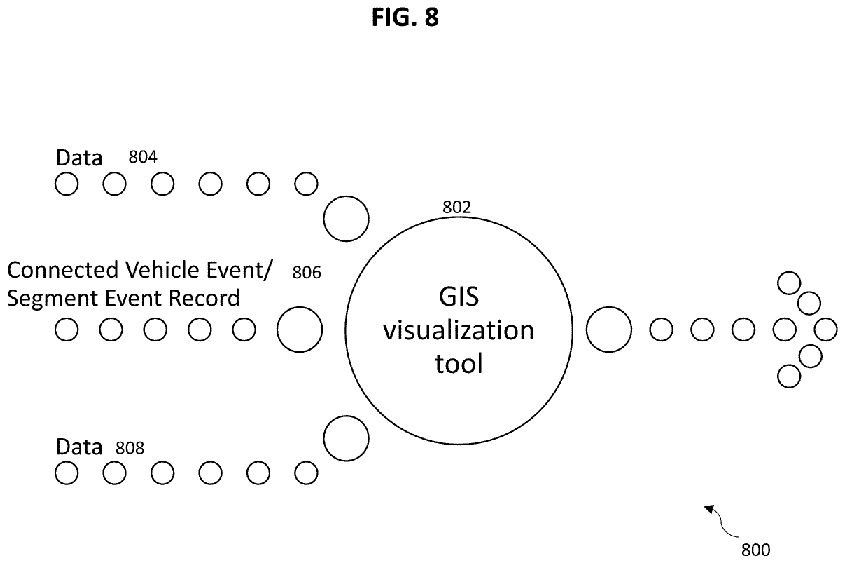

In an embodiment, the system 10 can be further configured to map the geohashed event data to a map database. The map database can be, for example, a point of interest database or other map database, including public or proprietary map databases as described herein. The system 10 can be further configured to produce mapping interfaces. An exemplary advantage of employing geohashing as described herein is that it allows for much faster, low latency enrichment of the vehicle event data when processed downstream. For example, geographical definitions, map data, and other enrichments are easily mapped to geohashed locations and Vehicle IDs. Feed data can also be combined into an aggregated data set and visualized using an interface, for example a GIS visualization tool (e.g.: Mapbox, CARTO, ArcGIS, or Google Maps API) as shown in FIG. 8 or other interfaces to produce and interface graphic reports or to output reports to third parties 15 using the data processed to produce the analytics insights, for example, via the Egress Server system 400 or Portal Server system 600.

In at least one embodiment, at block 208, the Stream Processor Server system 200 can be configured to anonymize the data to remove identifying information, for example, by removing or obscuring personally identifying information from a Vehicle Identification Number (VIN) for vehicle data in the event data. In various embodiments, event data or other data can include VIN numbers, which include numbers representing product information for the vehicle, such as make, model, and year, and also includes characters that uniquely identify the vehicle, and can be used to personally identify it to an owner. The system 10 can include, for example, an algorithm that removes the characters in the VIN that uniquely identify a vehicle from vehicle data but leaves other identifying serial numbers (e.g. for make, model and year), for example, a Squish Vin algorithm. In an embodiment, the system 10 can be configured to add a unique vehicle tag to the anonymized data. For example, the system 10 can be configured to add unique numbers, characters, or other identifying information to anonymized data so the event data for a unique vehicle can be tracked, processed and analyzed after the personally identifying information associated with the VIN has been removed. An exemplary advantage of anonymized data is that the anonymized data allows processed event data to be provided externally while still protecting personally identifying information from the data, for example as may be legally required or as may be desired by users.

In at least one embodiment, as described herein, a geohash to 9 characters can also provide unique identification of a vehicle without obtaining or needing personally identifying information such as VIN data. Vehicles can be identified via processing a database event data and geohashed to a sufficient precision to identify unique vehicles, for example to 9 characters, and the vehicle can then be identified, tracked, and their data processed as described herein.

In an embodiment, data can be processed as described herein. For example, un-aggregated data can be stored in a database (e.g. Parquet) and partitioned by time. Data can be validated in-stream and then reverse geocoded in-stream. Data enrichment, for example by vehicle type, can be performed in-stream. The vehicle event data can aggregated, for example, by region, by journey, and by date. The data can be stored in Parquet, and can also be stored in Postgres. Reference data can be applied in Parquet for in-stream merges. Other reference data can be applied in Postgres for spatial attributes.

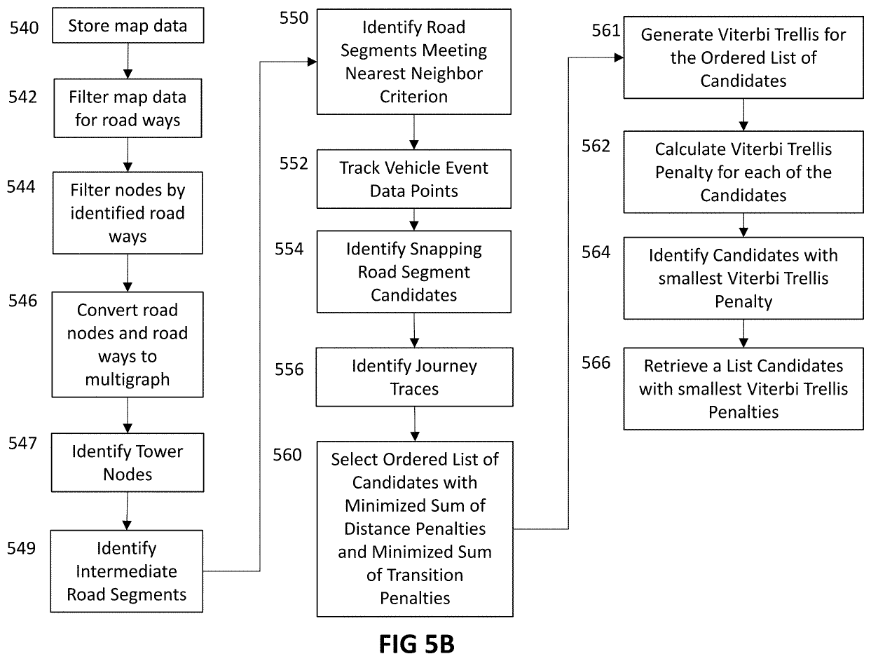

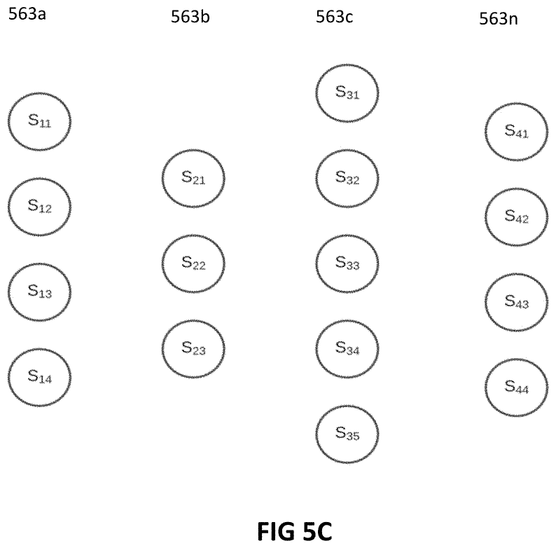

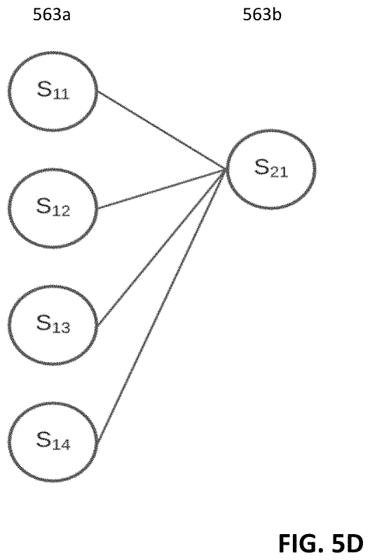

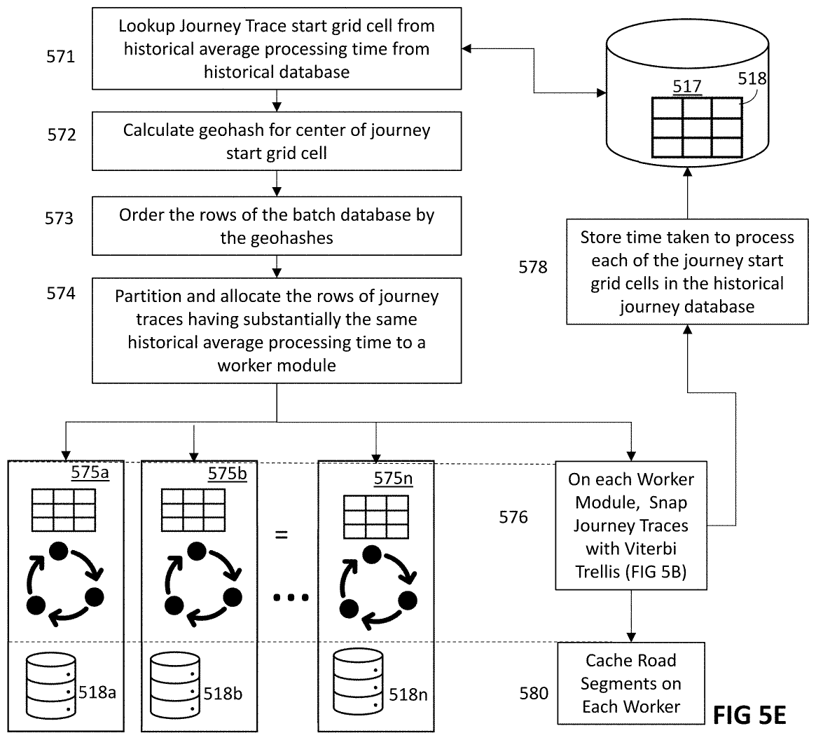

As noted above, for real-time streaming, at block 202, the data validation filters out data that has excess latency, for example a latency over 7 seconds. However, batch data processing can run with a full set of data without gaps, and thus can include data that is not filtered for latency. For example, a batch data process for analytics as described with respect to FIG. 5A can be configured to accept data up to 6 weeks old, whereas the streaming stack of Stream Processing Server system 200 is configured to filter data that is over 7 seconds old, and thus includes the latency validation check at block 202 and rejects events with higher latency.

In an embodiment, at block 212, both the transformed location data filtered for latency and the rejected latency data are input to a server queue, for example, an Apache Kafka queue. At block 214, the Stream Processing server system 200 can split the data into a data set including full data 216—the transformed location data filtered for latency and the rejected latency data—and another data set of the transformed location data 222. The full data 216 is stored in data store 107 for access or delivery to the Analytics Server system 500, while the filtered transformed location data is delivered to the Egress Server system 400. In another embodiment, the full data set or portions thereof including the rejected data can also be delivered to the Egress Server system 400 for third party platforms for their own use and analysis. In such an embodiment, at block 213 transformed location data filtered for latency and the rejected latency data can be provided directly to the Egress Server system 400.

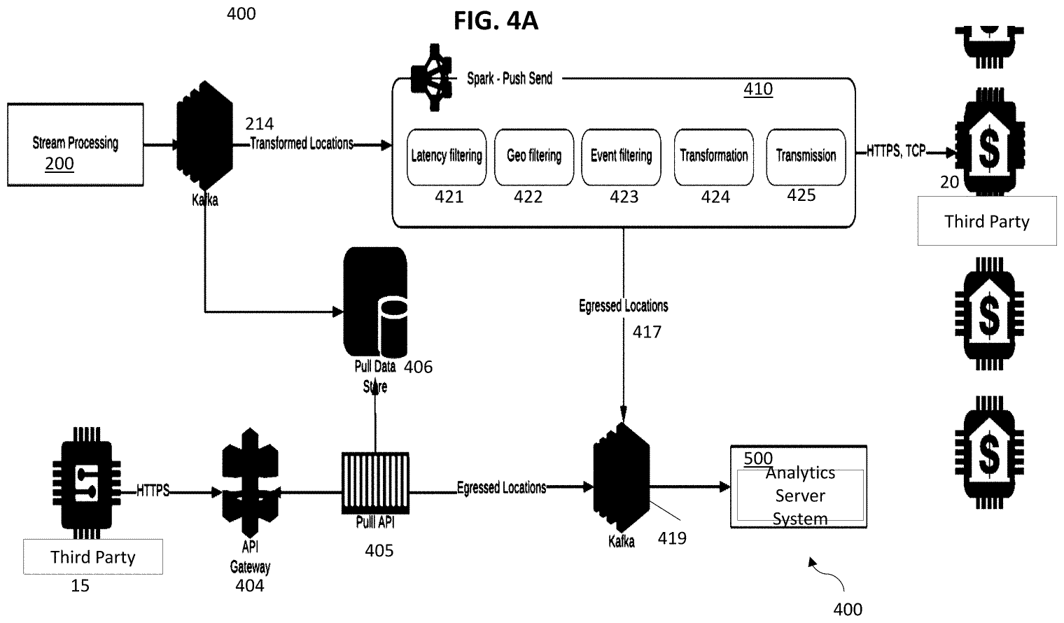

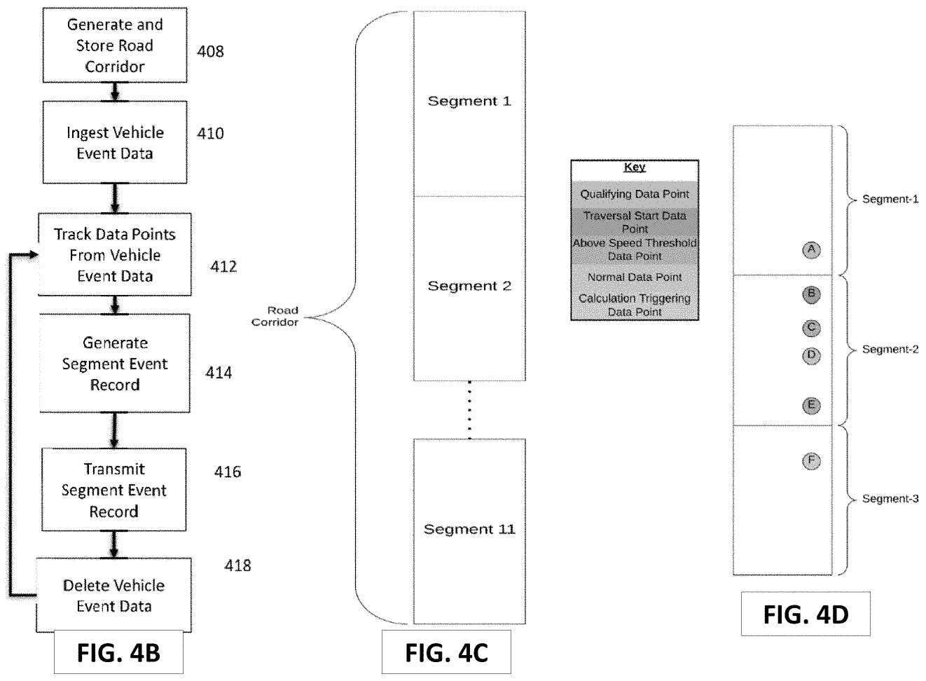

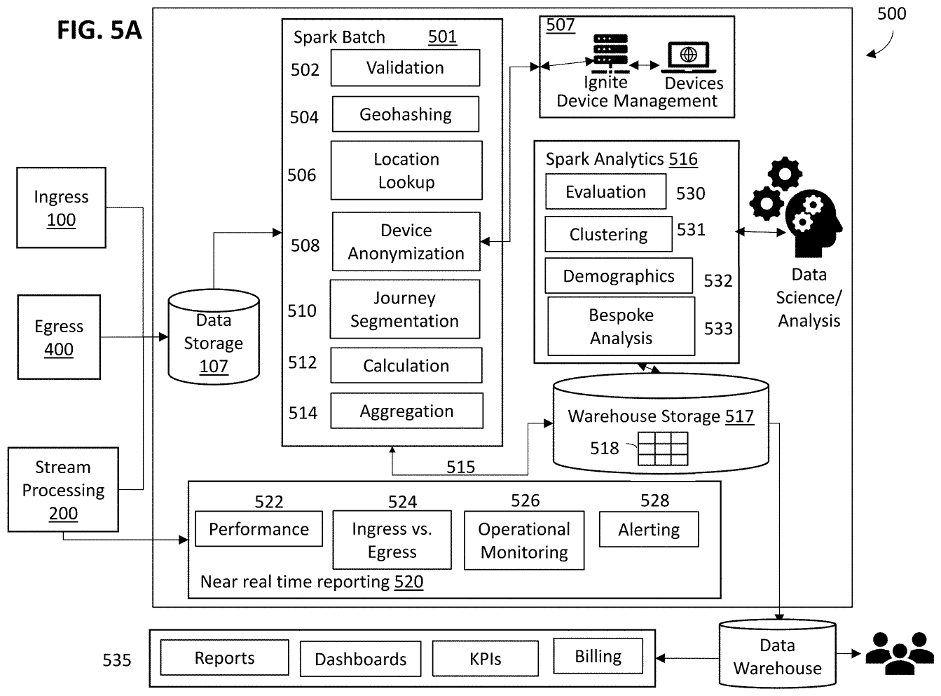

FIG. 4A is a logical architecture for an Egress Server system 400. In at least one embodiment, Egress Server system 400 can be one or more computers arranged to ingest, throughput records, and output event data. The Egress Server system 400 can be configured to provide data on a push or pull basis. For example, in an embodiment, the system 10 can be configured to employ a Push server from an Apache Spark Cluster or a distributed server system for parallel processing via multiple nodes, for example a Scala or Java platform on an Akka Server Platform. The push server can be configured to process transformed location data from the Stream Process Server system 200, for example, for latency filtering 421, geo filtering 422, event filtering 423, transformation 424, and transmission 425. As described herein, geohashing improves system 10 throughput latency considerably, which allows for advantages in timely push notification for data processed in close proximity to events, for example within minutes and even seconds. For example, in an embodiment, the system 10 is configured to target under 60 seconds of latency. As noted above, Stream Processing Server system 200 is configured to filter events with a latency of less than 7 seconds, also improving throughput. In an embodiment, a data store 406 for pull data can be provided via an API gateway 404, and a Pull API 405 can track which third party 15 users are pulling data and what data users are asking for.

For example, in an embodiment, the Egress Server system 400 can provide pattern data based on filters provided by the system 10. For example, the system 10 can be configured to provide a geofence filter 412 to filter event data for a given location or locations. As will be appreciated, geofencing can be configured to bound and process journey and event data as described herein for numerous patterns and configurations. For example, in an embodiment, the Egress Server system 400 can be configured to provide a “Parking” filter configured to restrict the data to the start and end of journey (Ignition—key on/off events) within the longitude/latitudes provided or selected by a user. Further filters or exceptions for this data can be configured, for example by state (state code or lat/long). The system 10 can also be configured with a “Traffic” filter to provide traffic pattern data, for example, with given states and lat/long bounding boxes excluded from the filters.

In an embodiment, the Egress Server 400 can be configured to process data with low-latency algorithms configured to maintain and improve low latency real-time throughput. The algorithms can be configured to process the data for low-latency file output that can populate downstream interfaces requiring targeted, real-time data that does not clog computational resources or render them inoperable. In an embodiment, the system 10 is configured to provide low latency average road speed data for road segments for output in virtually real time from a live vehicle movement data stream from the Stream Processing Server 200. The Egress Server 400 can also be configured to delete raw data in order and provide lightweight data packages to partners 20 and configured for downstream interfaces, for example via the Push Server.

As shown in FIG. 4B, in an embodiment, at block 408 the Egress Server 400 is configured with a road corridor comprising the road segments of interest and entry and exit segments defined by a set of consecutive polygons as described herein. At block 410, the system is configured to ingest high throughput real time vehicle movement event data, which includes standard trip event data ingressed by the Ingress Server 100 and processed by the Stream Processing Server 300, which includes data such as a device ID, lat/long, ignition status, speed, and a time stamp.

In an embodiment, at block 412 the system is configured to track data points for a vehicle as described herein with respect to FIGS. 4B-4D. The system is configured to provide, per vehicle, from a vehicle movement event data stream: a traversal time per vehicle across a road segment, an average speed per vehicle across a road segment; and a number of times a data point was received for a vehicle that was above a speed threshold for a road segment. In an embodiment, the interval between data points being captured from the vehicle can be, for example, 1-3 seconds.

FIGS. 4C-4D are diagrams showing a logical layout for a road corridor comprising a plurality of road segments. A road corridor is a part of a road where traffic is monitored. In an embodiment, a road segment can be defined by a polygon drawn around a given section of road. A polygon can be defined as three or more points that make up a two-dimensional shape around the section. A data point as used herein refers to a point denoted by a latitude and a longitude and the vehicle event data for that point. A road corridor comprises a number (n) of road segments of interest and an additional entry segment and exit segment. Accordingly, a road corridor is a series of consecutive road segments including at least 3 segments. As described below, at least three consecutive segments are employed to obtain vehicle data for a given segment when a vehicle traverses the segment.

In an example shown and described with reference to FIGS. 4C-4D, each of the road segments is 1531.06 yards as driven down the center of the road. However, the corridor can include any number at or above the three or more road segments, and the segments of the road corridor can be defined to be variable lengths.

The system is configured to calculate at segment traversal for a vehicle by monitoring a plurality of data points from the vehicle event data. A segment traversal is when a vehicle passes all the way through a road segment from one end to the other.

In an embodiment, as shown in FIG. 4D, at point A, the system records the vehicle event data for a specific Device ID when a vehicle is first identified in a segment 1. Point B is a traversal start data point, where the vehicle first identified at point A has crossed into segment 2. The event data at point A is thus a qualifying point that allows the system to qualify the vehicle as crossing the boundary from segment 1 into segment 2 at point B. At point B, the system establishes a vehicle state for the vehicle. Point B is used as the start point for the calculations, as the system confirms the vehicle crossed the boundary and has entered segment 2.

As shown in FIG. 4D, at points C, D and E the system records that the vehicle is still in segment 2. At point F, the system identifies that the vehicle has left segment 2 and has crossed into segment 3. Point E is a qualifying data point for segment 3. Thus, the system identifies that the vehicle has completed a segment traversal of segment 2. Point F thus acts as a trigger point for triggering calculations for segment 2.

At calculation triggering data point F, the system then calculates data for a segment event record for segment 2. The segment event record includes a traversal time and average speed for segment 2. A traversal time is the amount of time taken for a segment traversal. Traversal time is the captured time stamp of the first data point exiting outside the road segment minus the captured time stamp of the first data point inside the road segment in milliseconds. For example, in FIG. 4D, the traversal time for segment 2 is calculated as the time stamp at point F (the first data point exiting outside road segment 2) minus the time stamp for the traversal at point B (the first data point inside road segment 2).

Average speed is the segment distance divided by the traversal time. The average speed can be multiplied to obtain a desired order of magnitude. For a given capture rate for vehicle movement data points (e.g., 3 seconds), the exact distance driven will vary by record, and a fixed distance can be used when calculating average speed through the segment. For example, at 50 MPH a vehicle will have travelled approximately 73.3 yards in 3 seconds. In the example shown in FIGS. 4C-4D the segment distance 1531.06 yards is divided by (Traversal Time multiplied by 3600000) divided by 1760 to obtain an average speed in MPH accurate to 2 decimal places.

A worked example for a segment event record as shown in FIG. 4D is as follows: a vehicle enters the road segment at 12:00:00.342 having been seen in the previous segment (segment 1). The vehicle is identified is seen at 12:01:30.342 in the following road segment (segment 2). The traversal time is 12:01:30.342-12:00:00.342=90000 milliseconds. The average speed is ((1531.06/90000)*3600000)/1760=34.80 MPH. The system also generates a segment event record for segment 2 that includes a speeding count of 2.

Returning to FIG. 4B, at block 414, each time a vehicle completes a full segment (by entering from a previous segment and exiting into the next segment) a segment event record is generated. The segment event record comprises a Data Point ID, which is a unique ID to allow the system to internally audit against the individual data point that created the segment event. Accordingly, each segment event record has a Data Point ID to uniquely identify the segment record. The segment event record also includes a Segment ID, which is a unique ID for the segment. The segment event record also includes a Traversal Time, which is the time taken to traverse the segment in milliseconds, and an Average Speed, which is the average speed through the segment in MPH. In an embodiment, the segment event record can be generated in a JSON format. At block 418, each segment event record is generated and transmitted and partitioned on a per segment basis. In an embodiment, transmitted files can contain one or more segment event records within a payload array. In an embodiment, if no vehicle passes through a segment, no file is generated. An exemplary logical payload for a segment event record is shown in Table 6.

TABLE 6

| Attribute | | | |
|---|---|---|---|
| Name | Type | Description | Example |
| Id | String | Unique identifier for the | 123e4567- |
| | | derived record | e89b-12d3- |
| | | | a456- |
| | | | 556642440000 |
| Segment ID | Number | Unique identifier for the | 1 |
| | | segment | |
| Traversal | Number | The time it took to traverse the | 930000 |
| Time | | road segment in milliseconds | |
| Average | Decimal | The average speed across the | 50.56 |
| Speed | | road segment in MPH | |

As shown in FIG. 4C, where a road corridor has another segment (e.g.: segment 3) after a segment event record is calculated (e.g. for segment 2), point F is also a traversal start data point for that segment, which is qualified by point E. The system is thus configured to track the vehicle state purposes of generating another segment event record, but can discard raw data used to calculate the prior segment (segment 2) after the segment event record is generated. This process is repeated for each consecutive segment until the vehicle leaves any segment of the road corridor or meets one of the exception criteria as described below.

As shown in FIG. 4B, in an embodiment, at block 418 the system is configured to delete vehicle movement event data for a data point after a vehicle state is established and the time stamp is recorded in a segment event record. Once the system establishes the state of the vehicle at point B after the vehicle is qualified at point A as shown in FIG. 4C, the system employs the Data Point ID to track the vehicle through the segment. As each point is identified, the system no longer needs to retain the raw event data for the point in the Egress Server 400. As such, once the segment event record is created, the Egress Server 400 is configured to delete the raw data, to improve the latency of the system.

As explained herein, improved latency is not incidental to the design and implementation of the algorithm and segment event record container employed to egress segment events, as low latency is an important technical feature of the system. Further, light segment event record containers allow downstream consoles, for example traffic management consoles, to operate. For example, at block 416 of FIG. 4B, segment event records can be transmitted in real time to external partners 20 from the push server. For example, in an embodiment the segment record can be configured to be delivered from the push server to an interface such as an AWS S3 bucket, web sockets, or an API. In an embodiment, segment event records can be transmitted to the Analytics Server system 500 for insight processing and output to the portal server 600 for APIs or other interfaces. In an embodiment, for example, the segment event records can be transmitted to the Analytics Server system 500 for journey snapping and journey trace analysis as described herein. Then, at block 418 the system can be configured to delete the raw data from the Egress Server 400 to improve both the system's own latency and the operability downstream interfaces and consoles.

FIG. 5A represents a logical architecture for an Analytics Server system 500 for data analytics and insight. In at least one embodiment, Analytics Server system 500 can be one or more computers arranged to analyze event data. Both real-time and batch data can be passed to the Analytics Server system 500 for processing from other components as described herein. In an embodiment, a cluster computing framework and batch processor 501, such as an Apache Spark cluster, which combines batch and streaming data processing, can be employed by the Analytics Server system 500. Data provided to the Analytics Server system 500 can include, for example, data from the Ingress Server system 100, the Stream Processing Server system 200, and the Egress Server system 400.

In an embodiment, the Analytics Server system 500 can be configured to accept vehicle event payload and processed information, which can be stored in data stores, such as data stores 107. As shown in FIG. 5A, the storage includes real-time egressed data from the Egress Server system 400, transformed location data and reject data from the Stream Processing Server system 200, and batch and real-time, raw data from the Ingress Server system 100. As shown in FIG. 2, ingressed locations stored in the data store 107 can be output or pulled into the Analytics Server system 500. The Analytics Server system 500 can be configured to process the ingressed location data in the same way as the Stream Processor Server system 200 as shown in FIG. 2 and/or the Egress Server system 400. As noted above, the Stream Processing Server system 200 can be configured to split the data into a full data set 216 including full data (transformed location data filtered for latency and the rejected latency data) and a data set of transformed location data 222. The full data set 216 is stored in data store 107 for access or delivery to the Analytics Server system 500, while the filtered transformed location data is delivered to the Egress Server system 400. As shown in FIG. 5A, real time filtered data can be processed for reporting in near real time, including reports for performance 522, Ingress vs. Egress 524, operational monitoring 526, and alerts 528.

Accordingly, at block 502 of FIG. 5A, in at least one embodiment, the Analytics Processing Server system 500 can be configured to optionally perform validation of raw location event data from ingressed locations in the same manner as shown with block 202 in FIG. 2 and blocks 701-705 of FIG. 7. In an embodiment, as shown in FIG. 7, at block 706, the system 10 can employ batch processing of records to perform further validation on Attributes for multiple event records to confirm that intra-record relationships between attributes of event data points are meaningful. For example, as shown in Table 7, the system 10 can be configured to analyze data points analyzed to ensure logical ordering of events for a journey (e.g.: journey events for a journey alternate “TripStart—TripEnd—TripStart” and do not repeat “TripStart-TripStart-TripEnd-TripEnd).

TABLE 7

| Intra- | | | Data | Data Points |
|---|---|---|---|---|
| Record | | | Points | Flagged |
| Filtering | Attributes | Conditions | Flagged | (%) |
| Record | ignition_status | LEAD(ignition_ | 9125 | 0.0035% |
| ordering | | status) = ignition_ | | |
| logical. | | status AND | | |
| | | ignition_status <> | | |
| | | ‘MIDJOURNEY’ | | |

Referring to block 504 of FIG. 5A, in at least one embodiment, the Analytics Server system 500 can optionally be configured to perform geohashing of the location event data as shown in FIG. 2, block 204. At block 506 of FIG. 5A, the Analytics Server system 500 can optionally perform location lookup. At block 508 of FIG. 5A, the Analytics Server system 500 can be configured to optionally perform device anonymization as shown in blocks 206 and 208 of FIG. 2.

At block 510, in at least one embodiment, the Analytics Server 500 can perform a Journey Segmentation analysis of the event data. At block 512, the Analytics Sever 500 is configured to perform calculations to qualify a Journey from event information.

Returning to FIG. 5A, at block 510, in at least one embodiment, the Analytics Server system 500 performs a Journey Segmentation analysis of the event data. In an embodiment, the system 10 is configured to identify a Journey for a vehicle from the event data, including identifying whether a given vehicle's route or movement is for purposes of driving to a journey destination, wherein the journey identification comprises: identifying an engine on or a first movement for the vehicle; identifying an engine off or stop movement for the vehicle; identifying a dwell time for a vehicle; and identifying a minimum duration of travel.

In at least one embodiment, a Journey can comprise one or more Journey Segments from a starting point to a final destination. A Journey Segment comprises a distance and a duration of travel between engine on/start movement and engine off/stop movement events for a vehicle.

However, a real driver may have one or more stops when travelling to a destination. A Journey can have two or more Journey Segments, such as when there is a trip with multiple stops. For example, a driver may need to stop for fuel when travelling from home to work or stop at a traffic light. As such, a problem and challenge in vehicle event analysis includes developing accurate vehicle tracking for embodiments as described herein. While other Journey algorithms or processes have been employed in the art, for example reverse engineering a journey from a known destination of an identified vehicle, the present disclosure includes embodiments and algorithms that have been developed and advantageously implemented for agnostic vehicle tracking using the technology described herein, including the data analysis, databases, interfaces, data processing, and other technological products.

At block 512, the Analytics Server 500 is configured to perform calculations to qualify a Journey from event information. In an embodiment, the system 10 is configured with Journey detection criteria, including a duration criterion, a distance criterion, and a dwell time criterion. In at least one embodiment, the duration criterion includes a minimum duration criterion, where a minimum duration of travel is required for the system to include a Journey Segment in a Journey. A minimum duration of travel after engine on or a start movement can comprise a duration of time for travel, for example, from about 60 to about 90 seconds. In an exemplary embodiment, the system 10 can be configured require a vehicle travel more than 60 seconds for it to be included as a Journey Segment. For example, if an (1) engine on/ignition event or (2) an identified vehicle's first movement after a known last movement (e.g. from a previous trip or journey) or (3) a newly identified vehicle's first movement is identified for a vehicle, and the event is followed by a short duration of travel of less than 60 seconds, the system 10 is configured to exclude this Journey Segment from a Journey determination. The system 10 is configured to determine that the vehicle's short duration of movement is not a Journey start or destination.

In an embodiment, the Journey detection criterion includes a distance of travel criterion, for example 200 meters. The system 10 can be configured to exclude distances of 200 meters or less from a Journey segment. A minimum distance of travel criterion can comprise a predetermined duration of distance for travel, for example, from about 100 meters to about 300 meters. The minimum distance x (e.g. 200 meters) can be defined to an index including about 50% tolerance of the minimum distance x.

In an embodiment, a dwell time criterion can include a stop time for a vehicle. For example, a dwell time criterion can be from about 30 to about 90 seconds. A maximum dwell time can comprise a duration of stopping between an engine off/stop movement and engine on/start movement for the same vehicle, for example, from about 20 to about 120 seconds. For example, if the system 10 determines a vehicle is stopped or its engine is off for less than 30 seconds, the system can be configured not to include that stop period as the end of a Journey or in a Journey object.

As described above, in an embodiment, the system 10 is configured to process vehicle event data to determine if one or more Journey Segments comprise a Journey for a vehicle. For example, an engine on or start movement event can be followed by a distance exceeding a distance criterion (e.g. over 200 meters). Thus, the system's duration criterion does identify this segment for a Journey. However, if the car stops thereafter and continues to stay stationary for over 30 seconds, the system 10 is configured not to count that as a segment for a Journey. If the vehicle subsequently stops for less than 30 seconds and then moves again, the Dwell time criterion is met, and the system 10 is configured to include that Journey Segment in the Journey for that vehicle's travel to its final destination. Thus, the algorithm can join a plurality of Journey Segments for a Journey or a Journey object for an everyday real time drive a destination, for example, when a driver turns a car on (engine on/start movement) at home, drives for 10 miles (Distance criterion), stops at a stop light for 29 seconds, travels on to a final destination at work (engine off/stop movement). However, the system 10 is configured to ignore events that are unlikely to represent an interruption in a Journey, for example stopping at a stop light for 29 seconds (Dwell criterion) or movement less than 200 meters (Distance criterion) or less than 60 seconds (Duration criterion).

In an embodiment, the system 10 can include a plurality of criteria for each of the dwell criterion, the distance criterion, or the time criterion, for example, based on variable data. Thus, the algorithm can join a plurality of Journey Segments for a Journey for a common real time drive to a destination where additional data is known about the vehicle and the location. For example, if a vehicle is identified as a road legal electric vehicle such as an electric car, the dwell criteria can include a dwell time maximum criterion of 20 minutes at a location identified as an electric charging station. Thus, the dwell time can be extended up to between 2-20 minutes, based on, for example, other data about the location (e.g., data indicating the stop is a point of interest such as a gas station, rest area, or restaurant). The system 10 can be configured to identify a Journey when a driver of an electric car turns the car on (engine on or first movement) at home, drives for 100 miles (Distance criterion) to a charging station for charging (engine off/stop movement, 12 minutes, Dwell criterion, variable, charging station), then starts again (engine on/start movement) and travels on to a final destination at a sales meeting (engine off/stop movement). Accordingly, as will be appreciated, each of the criteria above can be configured to be variable depending on, inter alia, knowledge derived or obtained about an event vehicle data point.

In an embodiment, the system 10 is configured to identify candidate chains of Journey segments for a given device according to the criteria described above. Also, a compound Journey object can be instantiated with its start being the beginning of the chain and its end being the end of the final segment in the chain. A separate table of Journey objects can be extracted from event data and derived compound Journeys can be generated into a further table. In an embodiment, a data set including all engine on/engine off or start movement/stop movement events are identified to a unique vehicle ID. For example, each of the engine on/engine off or start movement/stop movement events for a vehicle can be placed on a single row including the candidate Journey segments. Then, row of engine on/engine off or start movement/stop movement events can be processed by each of the distance criterion, duration criterion, and dwell criterion to determine which Journey segments can be included or excluded from a Journey determination for a Journey object. In an embodiment, the system 10 can generate a further Journey Table, which is populated with Journey objects as determined from the events for the vehicle that meet the Journey criteria above.

In at least one embodiment, at block 514, the system 10 is configured to provide active vehicle detection by analyzing a database of vehicle event data and the summarizing of a journey of points into a Journey object with attributes, such as start time, end time, start location, end location, data point count, average interval and the like. In an embodiment, Journey objects can be put into a separate data table for processing.

In an exemplary embodiment, the system 10 can be configured to perform vehicle tracking without the need for pre-identification of the vehicle (e.g. by a VIN number). As described above, geohashing can be employed on a database of event data to geohash data to a precision of 9 characters, which corresponds to a shape sufficient to uniquely correlate the event to a vehicle. In an embodiment, the active vehicle detection comprises identifying a vehicle path from a plurality of the events over a period of time. In an embodiment, the active vehicle detection can comprise identifying the vehicle path from the plurality of events over the period of a day (24 hours). The identification comprises using, for example, a connected components algorithm. In an embodiment, the connected components algorithm is employed to identify a vehicle path in a directed graph including the day of vehicle events, in which in the graph, a node is a vehicle and a connection between nodes is the identified vehicle path. For example, a graph of journey starts and journey ends is created, where nodes represent starts and ends, and edges are journeys undertaken by a vehicle. At each edge, starts and ends are sorted temporally. Edges are created to connect ends to the next start at that node, ordered by time. Nodes are 9 digit geohashes of GPS coordinates. A connected components algorithm finds the set of nodes and edges that are connected and, a generated device ID at the start of a day is passed along the determined subgraph to uniquely identify the journeys (edges) as being undertaken by the same vehicle.

An exemplary advantage of this approach is it obviates the need for pre-identification of vehicles to event data. Journey Segments from vehicle paths meeting Journey criteria as described herein can be employed to detect Journeys and exclude non-qualifying Journey events as described above. For example, a geohash encoded to 9 digits (highest resolution) for event data showing a vehicle had a stop movement/engine off to start movement/engine on event within x seconds of each other (30 seconds) can be deemed the same vehicle for a Journey. For a sequence of arrives and leaves, a Journey can be calculated as the shortest path of Journey Segments through the graph.

In at least one embodiment, at block 515, the system 10 can be configured to store the event data and Journey determination data in a data warehouse 517. Data can be stored in a database format 518. In an embodiment, a time column can be added to the processed data. In an embodiment, the database can also comprise Point of Interest (POI) data.

The Analytics Server system 500 can include an analytics server component 516 to perform data analysis on data stored in the data warehouse 517, for example a Spark analytics cluster. The Analytics Server system 500 can be configured to perform evaluation 530, clustering 531, demographic analysis 532, and bespoke analysis 533. For example, a date column and hour column can be added to data to processed Journey data and location data stored in the warehouse 517. This can be employed for bespoke analysis 533, for example, determining how many vehicles at intersection x by date and time. The system 10 can also be configured to provide bespoke analysis 533 at the Egress Server system 400, as described with respect to FIG. 4A.

In an embodiment, a geospatial index row can be added to stored database 518 in warehouse 517 data, for example, to perform hyper local targeting or speeding up ad hoc queries on geohashed data. For example, location data resolved to 4 decimals or characters can correspond to a resolution of 20 meters or under.

The Analytics Server 500 can be configured with diagnostic machine learning configured to perform analysis on databases of invalid data with unrecognized fields to newly identify and label fields for validated processing.

In an embodiment, the system 10 can be configured to process vehicle event data to provide enhanced insights and efficient processing. Exemplary processes and systems for processing event data comprise:
K nearest neighbors over an R-Tree with graph local searching and custom metrics for performing snapping of data points to roads;
DBSCAN with custom metrics for finding areas of parking related to points of interest;
XGBoost for classification of journey purpose with a classifier modified from one built over National Household Travel Survey data;
Levenshtein and Soundex for street address matching;
ARIMA for traffic volume time series forecasting;
Cross correlation and dynamic time warping for determination of road co-dependency;
Facebook Prophet for datapoint volume forecasting;
Gaussian Mixture Model for identifying traffic congestion state; and
XmR for anomaly detection control charting.

The Analytics Server system 500 can be configured to perform road snapping as described with respect to the Ingress Server system 100 hereinabove. The algorithm as described above advantageously can use individual points for snapping, and extracts as much information as possible from each data point by comparing each data point to road geometry. The data point can also be compared to statistics formed from aggregated data. In an embodiment, the snapping algorithm is implemented at an ingress server to provide, inter alia, advantages in substantially real-time, low latency feeds. In an embodiment, the snapping algorithm can also be provided at the Stream Processing server system 200, Egress Server system 400, or Analytics Server system 500. In an embodiment, the system 10 can be further configured to map the event data to a map database as described herein.

In an embodiment, a base map is given as a collection of line segments. The system 10 can be configured to include a base map given as a collection of line segments for road segment, for example employing an R-Tree index as described herein. As disclosed herein, the system 10 includes, for each line segment, geometrical information regarding the line segment's relation to its nearest neighbors. For each line segment, statistical information regarding expected traffic volumes and speeds is generated from an initial iteration of the process. Vehicle movement event data comprises longitude, latitude, heading, speed, and time-of-day. As described herein, vehicle movement event data is geohashed, for example to a 6 character geohash. Vehicle movement event data enriched with the geohash can be map-matched to the base map.

One exemplary advantage of the system 10 is that among large data set of vehicle movement data, the system can be configured to be highly selective and yet correct map interfaces at a high degree of resolution. For example, the system 10 can identify and correct map data and interfaces from at least and as many as 10 million geohashes in the United States.

Another exemplary advantage is map interfaces and navigation systems can be improved to accurately navigate vehicles.

In another embodiment, proceeding from the map matching enrichment described above, the Analytics Server 500 or Egress Server 400 can be configured to analyze movement data from vehicle event movement data points. The system 10 is configured to generate road segments with unique segment IDs as described herein with respect to FIGS. 4A-4D and obtains lengths of the road segments. Through map matching, the system can be configured to analyze vehicle event data to locate each vehicle data point onto a road segment. Each point has associated with it a distance it has been moved in order to make the match. As explained above, roads are represented as a single line segment in the map, so a match distance can show the presence of lanes on a road. The vehicle event data points are thus processed through the map matching system to determine the identification of a segment of road. The data includes, for example, Segment ID, Segment Length, Journey ID, Timestamp and Speed, transitions, and geolocation.

In an embodiment, the system is configured to perform enhanced road snapping for journey traces. FIG. 5B is a flowchart illustrating system flow for performing enhanced road snapping for journey traces. As shown in FIG. 5B, at block 540 the system intakes and stores map data comprising road network data in a map database, the road network data comprising nodes and road ways. Road network data can be obtained from map databases as described herein, for example, OpenStreetMap (OSM). Nodes identify a specific point on the Earth's surface defined by its latitude and longitude. Ways identify a geographical feature defined by either a line (such as, for example, rivers and roads) or closed loops (such as, for example, boundaries or building extents). A way is defined by an ordered collection of nodes. Relations identify a higher-level relationships between multiple nodes and/or ways. Tags are tags for all types of data elements, which can have many key-value pair tags. Tags describe the meaning of the element to which they are attached.

At block 542, the map data is filtered using the tags to identify ways that are road ways. The map data is filtered and uses the tags to filter the list of ways to all those which describe roads. At block 544 the map data is filtered by the nodes of the identified road ways to identify the road nodes. For example, in an embodiment, the list of nodes is filtered to include only those nodes on road ways. At block 546, the system 10 then is configured to convert the road nodes and the road ways into the multigraph. In an embodiment the conversion comprises, at block 547, identifying as the tower nodes the nodes that are either a terminal node of a road way or a node included in a plurality of road ways (a tower node included in a plurality of road ways being either a dead end or an intersection).

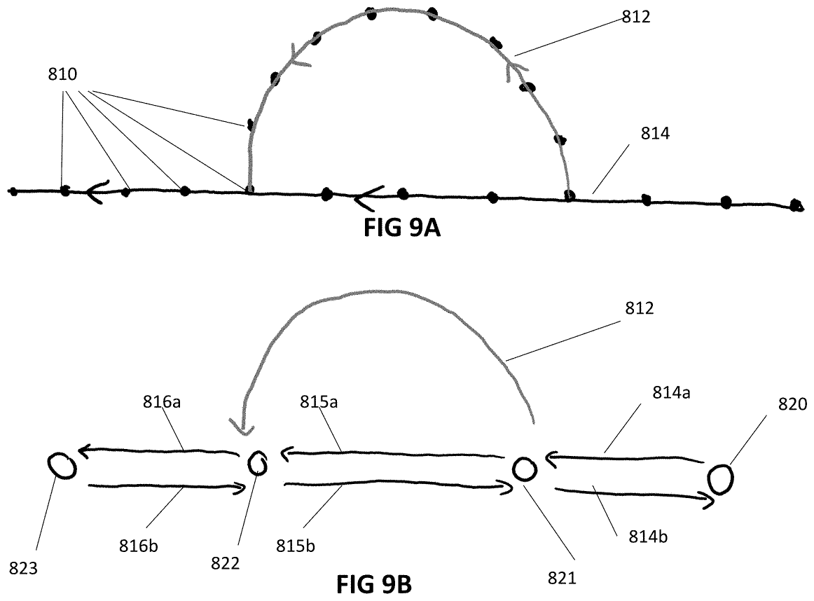

FIG. 9A shows a simplified example multigraph of nodes filtered to identify road nodes 810 on road ways 812, 814. FIG. 9B shows a simplified exemplary multigraph of generating tower nodes 820, 821, 822, 823 and identifying road segments between tower nodes 812, 814, 815, 816. The simplified multigraph of FIG. 9B shows the road nodes and the road ways into the multigraph. In an embodiment the conversion comprises, at block 547, identifying as the tower nodes 820, 821, 822, 823 the nodes 810 that are either a terminal tower node 820, 823 of a road way 812, 814, 815, 816 or tower nodes 821, 822 included in a plurality of road ways 812, 814, 815, 816.

At block 548, the system 10 is configured to generate a road segment for any two tower nodes that lie along a common road way. In an embodiment, a condition for generating the segment is that the tag for the road way is a directional tag indicating the direction of the road way is permitted. For example, a road segment can be created for any two consecutive tower nodes that lie on the same way such that the ordering of the tower nodes is permissible based on the one-way tag of the way. A reverse tag can be defined for the road segment by reversing the terminal tower nodes along the common road way, wherein a condition of generating the reverse is a directional tag indicating the direction of the reverse is permitted. Thus, for example, a reverse would not be permitted for a road segment tagged or determined to be a one-way road way.

As shown in FIG. 9B, one sequence of road segments 814a, 815a, 816a is tagged to allow a reverse 814b, 815b, 816b, and has two directions. However, another road segment 812 between tower node 821 and tower node 822 is tagged as a one-way, and thus a reverse tag is not permitted.

Returning to FIG. 5B, at block 549, the system 10 is configured to identify a chain of intermediate road segments for a sequence of road segments between a start tower node and an end tower node. In an embodiment, for a road segment s, a start tower node start and an end tower node s.end are given. A length (s) is given to indicate the length of the segment s measured as a subsection of its parent way. A segment reverse is designated s\hat{ }. For a sequence of segments s₁, s₂, . . . sₙ, the segments form a chain when:
sᵢ.end=sᵢ₊₁.start for i=1, 2, . . . n−1 and write s₁→s₂→ . . . →sₙ.
   In an embodiment, for the conversion of the road tower nodes and the road segments into the multigraph, the system can be configured to determine whether the chain includes a u-turn. For example, a chain s₁→s₂→ . . . →sₙ includes a u-turn if sᵢ=sᵢ₊₁\hat{ } for some i=1, 2, . . . n−1.

At block at block 550, the system is configured to identify a segment meeting a neighbor distance criterion as neighbor segments.

In an embodiment, the neighbor distance criterion is defined as:

```
(a: segment, d: distance) :=
{ b FROM Segments WHERE EITHER a → b OR exists s₁, ..., sₙ
  (n ≥ 1) such that a → s₁ → s₂→ ... → sₙ → b;and
  Σᵢ₌₁ⁿ length(sᵢ) < d}
```

The system is configured to identify those neighbors of a segment that a vehicle travels to in a 3 second period. For example, in an embodiment, the neighbor distance criterion can be configured with an upper limit distance of 200 meters, which allows for vehicles travelling at 150 mph. However, the neighbor distance criterion can be configured with a different minimum distance. For example, where mapping data or vehicle tracking data indicates or predicts speed limit for a road, the upper distance limit could be lowered to, for example, 100 meters for a vehicle travelling at 75 mph or even lower.

Using the neighbor distance criterion, which can vary from segment to segment, a>>b signifies that b is a neighbor of a. Given a>>b, there can be more than one chain of intermediate segments a→s1→s2→ . . . →sn→b that meet the neighbor distance criterion. In order to select a single chain, the list can first be ordered by whether or not the chain contains a uturn, and next by Σᵢ₌₁ⁿ length(sᵢ). In some cases, this process is sufficient to define a unique chain for any pair of neighbors a>>b. This unique chain forms the intermediate segments. As will be appreciated, the chain can be empty when the nearest neighbor segment is a terminal node (i.e.: when a→b).

In an embodiment, the system is configured to process location event data at the server to identify a journey trace for a road segment. At block 552, the system 10 is configured to ingest and track vehicle event data of a vehicle as described herein to locate a plurality of vehicle event data points (also referred to as o: observation) for the road segment, each data point comprising a longitude, a latitude, a heading, a speed, and a captured timestamp.

At block 554, the system 10 is configured to identify a plurality of point snapping road segment candidates for the each of the vehicle event data points. As described above the system 10 is configured to take a collection of line segments, which corresponds to road segments, and create an R-Tree index over the collection of line segments. R-trees are tree data structures used for spatial access methods, i.e., for indexing multi-dimensional information such as geographical coordinates, rectangles or polygons. The R-tree is configured to store spatial objects as bounding box polygons to represent, inter alia, road segments. The R-Tree is first used to find road segment candidates within a prescribed distance of a coordinate in order to snap a data point. In an embodiment, the system 10 can be configured to obtain a set of snapping candidates with the algorithm:

RTREE_QUERY(longitude, latitude, distance) :=
{
s FROM Segments
such that a bounding box for s intersects a bounding box centered at (longitude, latitude)
with edges of length distance

In an embodiment, the system can be configured to perform point snapping or road snapping as described with respect to the Ingress Server system 100 and Egress Server System 200 hereinabove. For example, at block 556, the system is configured to identify a journey trace comprising an ordered set of the plurality of the road segments defining a most likely path taken by a vehicle, where each road segment in the ordered set is obtained from the plurality of point snapping candidates for a plurality of corresponding location event data points. The system 10 can be configured to also apply a penalty for point snapping between the vehicle event data point and a road segment. For example, the system could apply penalty as described above with respect to the Ingress Server system 100. In an embodiment, the system can be configured to apply a penalized squared distance between the vehicle event data point and a road segment. For example, the system 10 can be configured to identify the vehicle event data point to a road segment with a point snapping algorithm:

POINTSNAP(o: observation) :=
arg min { SDPEN(o, s) }
for s in RTREE_QUERY(o.longitude, o.latitude, radius)

In an embodiment, the parameter radius can be chosen to be a distance beyond which a vehicle event data point or observation is not reasonably deflected from the vehicle's true position, for example a 100 m.

The system can then calculate the penalized square distance as:

SDPEN(o: observation, s: segment) :=
Distance((o.longitude, o.latitude), s)2 + PenaltyFunction(o, s)

As discussed above, one or more road segments to which the given vehicle event data point may be snapped are identified based on a distance being within a predetermined radius, for example, which may be referred to as a point snapping bounding radius. Each of the road segments candidates to which the vehicle event data point may be snapped may be associated with one or more penalties that are used when determining a journey trace, as discussed above. These one or more penalties may include a point snapping penalty, which is based on the distance between the vehicle event data point and the road segment candidate. At least in some embodiments, the one or more penalties also includes a transition penalty which is applied between road segments, as discussed above. Further, in some embodiments such as the embodiment of FIG. 9, for a given vehicle event data point, in addition to identifying one or more road segments to which the given vehicle event data point may be snapped, a fixed snap candidate may be included as a specialized road segment or element that is akin to a point snapping road segment candidate but is deemed to be fixed (a “fixed snap candidate”) since it is assigned or attributed a fixed penalty rather than one based on a distance between a road segment location and the vehicle event data point. As discussed generally above, the point snapping penalties may be set using a point snapping distance penalty function that is based on a distance between the vehicle event data point and the road segment candidate (referred to as a “snapping distance”). A max point snapping penalty may be defined as the maximum penalty that may be accorded a point snapping road segment candidate, which may correspond to inputting the point snapping bounding radius into the point snapping distance penalty function. In one embodiment, for example, the fixed snap penalty is set to the max point snapping penalty. However, in other embodiments, the fixed snap penalty is set to another value, such as a value greater than the max point snapping penalty. And, in other embodiments, the fixed snap penalty is set to a different value, such as a value that is less than the max point snapping penalty; for example, the fixed snap penalty may be set to a value that is less than max point snapping penalty, but greater than a mean or median value of the point snapping penalties taken from the other point snapping road segment candidates.

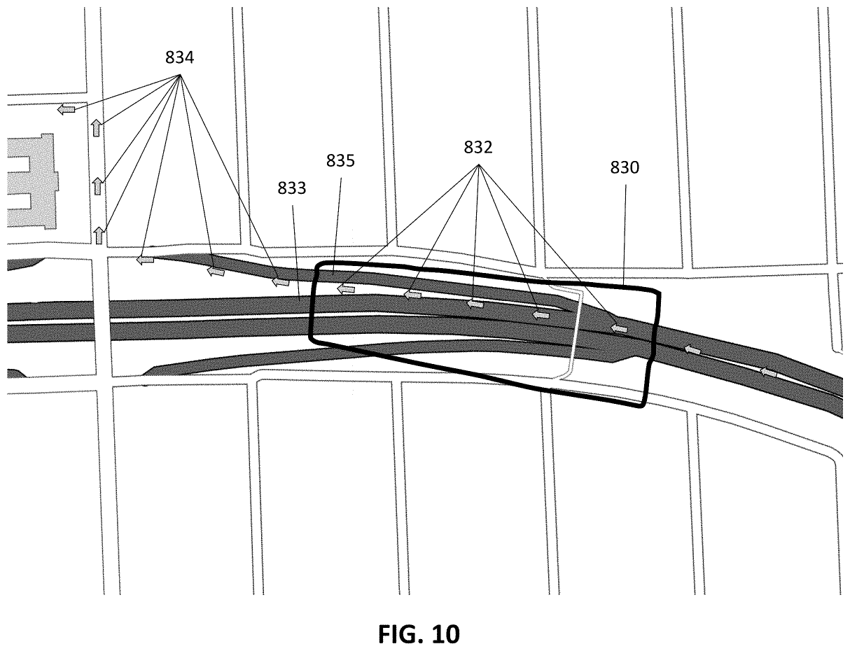

While in some cases, point snapping with a penalty as described above is sufficient to accurately snap a vehicle event point to a segment, in a number of cases accuracy can be further improved by employing processes described below. A simplified example of a misapplied point snapping is shown in FIG. 10. After-the-fact analysis of point snapping can reveal that a different candidate should have been chosen given the context of the preceding or following points. In the simplified example of FIG. 10, considering the points individually without context, every point 832 in the box 830 for a segment would be snapped to the freeway 833 using point snapping as described above. Looking at the later points 833 of the vehicle in context, the vehicle in fact exited along a slip road 835, and these points 833 would be better snapped to the segment for slip road instead. Accordingly, the system 10 can be configured to employ a journey snapping algorithm to leverage journey tracing for improved road snapping.

In an embodiment, a journey trace comprises an ordered collection of vehicle movement event points (observations). For a given a journey trace, the system is configured to find a corresponding ordered list of segments such that each segment in the list is taken from a set of road snapping candidates for the corresponding vehicle event point from the journey trace such that the segments represent the “most likely” path taken by the vehicle. In an embodiment, the system finds the most likely path by identifying the ordered list of segments which has a lowest overall penalty, which is based on a sum of all the penalized distances of each of the selected segments (the point snapping penalties) along with the sum of all the transition penalties between consecutive segments. As will be appreciated, there can be a vehicle event data point or observation within the journey trace for which the set of road snapping candidates is empty. In order to handle this situation, the system can be configured to split the journey trace into two sections for this observation. This operation can be repeated more than once if needed.

Also, according to some embodiments, as discussed above, a fixed snap candidate may be included as a point snapping road segment candidate. The fixed snap penalty represents one or more penalties that are fixed or predetermined, such as, for example, a point snapping penalty and/or a transition penalty. Thus, in some embodiments, determining the journey trace (or “most likely” path) includes considering candidate journey traces that have a fixed snap candidate as one of the road segments in the ordered list of segments, and the fixed snap candidate includes a fixed point snapping penalty and a fixed transition penalty. As discussed above, the fixed point snapping penalty and the fixed transition penalty may be predetermined and not based on a distance between the vehicle event data point and the road segment/fixed snap candidate. It should be appreciated that, in some embodiments, the fixed snap candidate may include or be associated with a location, which may be defined by a latitude and longitude.

In an embodiment the system 10 is configured to calculate a transition penalty for a plurality of the location event data points for a vehicle traveling between consecutive road segments of the sequence of road segments. As noted above, the system 10 is configured to select the ordered list of road segment candidates which has a lowest overall penalty, which may be one that minimizes a sum of all the penalized distances of each of the selected road selected along with a sum of all the transition penalties between consecutive road segments. A transition penalty is a penalty for travel between two segments that is deemed to be unlikely given the relative position of the two segments within the directed graph. This will be zero for segments which are neighbors, apart from those neighbors that involve a u-turn, which will incur a fixed penalty. Segments which are not neighbors also incur a higher fixed transition penalty. In an embodiment, the transition penalty algorithm comprises:

TRPEN(s1 : segment, s2 : segment) :=
WHEN s1 >> s2 and the intermediate road segments do not contain a u-turn
THEN 0
WHEN s1 >> s2 and the intermediate road segments contain a u-turn THEN
U_TURN_PENALTY
ELSE NO_TRANSITION_PENALTY

wherein the identifying of the chain of intermediate segments for a sequence of segments is si.end=si+1.start for i=1, 2, . . . n−1 and s1→s2→ . . . →sn, and the chain includes a u-turn if a segment includes a reverse.

At block 560, the system 10 is configured to identify the ordered list of the plurality of road segments which minimizes a sum of all the penalized distances of each of the selected road segments along with a sum of all the transition penalties between consecutive segments comprising the algorithm:

JOURNEY_SNAP((o₁, o₂, ...., oₙ) : Sequence[Observation]) :=
arg min (Σᵢ₌₁ⁿ SDPEN(oᵢ, sᵢ) + Σᵢ₌₁ⁿ⁻¹ TRPEN(sᵢ, sᵢ₊₁) )
for (s₁, s₂, ..., sₙ) : Sequence[Segment]

where sᵢ in RTREE_QUERY(oᵢ.longitude, oᵢ.latitude, radius). As will be appreciated, the returned sequence of segments may not form a chain.

As will be also be appreciated, a computational brute force search of a list of all possible paths through the list of road snapping candidates at each block would take an exponential amount of computation. As a solution to this technical problem, in an embodiment, the system is configured to run a Viterbi algorithm to improve the search and search computational efficiency.

At block 561, for the road segment candidates for each location event data point, the system is configured to generate a Viterbi trellis. For example, referring to the graph of FIG. 5C, for a journey trace (o₁, o₂, . . . , oₙ), for each i of a set of road segments {sᵢ₁, sᵢ₂, . . . }=RTREE_QUERY(oᵢ.longitude, oᵢ.latitude, radius) be the snapping candidates for observation oᵢ. The system 10 is configured track the calculations in the Viterbi trellis.

As shown FIG. 5C, for the columns of road segments in the Viterbi trellis, the system generates a link back to another of the road segment candidates in a previous column of the Viterbi trellis. Accordingly, each road segment element in the trellis includes two pieces of data. First a link back to a road segment element in the previous column in the trellis (TRELLIS_BACKLINK). Secondly a running total of trellis penalties calculated through the trellis TRELLIS_PENALTY.

At block 562, the system is configured to calculate a trellis penalty for each of the road segment candidates in the Viterbi trellis. In an embodiment, the trellis penalty comprises a running total of the penalized squared distance penalties from a first of the location event data point observations. The system is configured to work in the order represented in the trellis of FIG. 5C from top to bottom then left to right, completing the entries in one full column 563a, 563b, 563c, 563n at a time before moving to the next. As shown in FIG. 5D, a first column 563a of the Viterbi trellis comprises a dummy element for the link back from the road segments in the second column 563b to the road segment candidate in the first column.

For each road segment element S₁₁, S₁₂, S₁₃, S₁₄ in the first column 563a is a dummy element for the TRELLIS_BACKLINK, and a penalized squared distance from the first observation in the TRELLIS_PENALTY.

| | |
|---|---|
| s₁₁.TRELLIS_BACKLINK = DUMMY | s₁₃.TRELLIS_BACKLINK = DUMMY |
| s₁₁.TRELLIS_PENALTY = SDPEN(o₁, s₁₁) | s₁₃.TRELLIS_PENALTY= SDPEN(o₁, s₁₃) |
| s₁₁.TRELLIS_BACKLINK = DUMMY | s₁₄.TRELLIS_BACKLINK = DUMMY |
| s₁₂.TRELLIS_PENALTY = SDPEN(o₁, s₁₂) | s₁₄.TRELLIS_PENALTY = SDPEN(o₁, s₁₄) |

As shown in FIG. 5D, for a segment in the next column 563b—for example S₂₁—each of the road segment elements S₁₁, S₁₂, S₁₃, S₁₄ from the previous column 563a are calculated.

For each of the previous elements s₁ᵢ (i=1, 2, 3, 4), the system calculates the sum:

s₁ᵢ.TRELLIS_PENALTY+TRPEN(s₁ᵢ, s₂₁)

When the value finds a minimum, for example with the segment s₁ₖ, the system updates the trellis:

s₂₁.TRELLIS_PENALTY = s₁ₖ.TRELLIS_PENALTY + TRPEN(s₁ₖ,s₂₁) + SDPEN(o₂,
s₂₁)
s₂₁.TRELLIS_BACK_LINK = s₁ₖ

The system then continues the calculation for each of the segments S₂₁, S₂₂, S₂₃ in the second column 563b, then repeats the process on the third column 563c and then again on subsequent columns 563n in the same fashion.

In embodiments, when a fixed snap candidate is used as (or in a manner akin to) a point snapping road segment, then the trellis penalty (TRELLIS_PENALTY) may be set to a zero-valued penalty (or no penalty), a predetermined/fixed penalty, or a modified trellis penalty (e.g., using a multiplier to modify the output of the TRELLIS_PENALTY function). Additionally or alternatively, a fixed transition penalty or fixed trellis back link penalty may be used as a part of the method.

At block 564, the system 10 is configured to identify the road segment candidate in the Viterbi trellis that has the smallest trellis penalty when the Viterbi trellis is completed upon reaching the final column 563n in the trellis. Once the system completes the trellis, the system identifies road segment element in the final column 563n which minimizes the trellis penalty TRELLIS_PENALTY. The system can then trace back through the trellis via the trellis backlinks TRELLIS_BACKLINK one column 563n, 563c, 563b, 563a at a time and retrieve a full list of segments. At block 566, the system 10 retrieves, via the Viterbi trellis, a list of the road segment candidates that have the smallest trellis penalty. Journey traces and journey segments can be saved in a historical Journey database 518 as described above, for example in warehouse storage 517.

Though a simple example is given, in practice, in an embodiment, large volumes of batch vehicle event data—for an entire country for example—are being processed for road snapping and journey tracing as described above. In an embodiment, the system can be configured to process large volumes of batch data at scale. FIG. 5E illustrates a logical architecture flow for batch processing by the Analytics Server system 500 for data analytics and insight. As noted above, in an embodiment, the algorithm can also be provided at the Ingress Processing Server system 100, Stream Processing server system 200, Egress Server system 400, or Analytics Server system 500 in conjunction with a batch processing architecture, for example a cluster computing framework and batch processor 501 and analytics server 516 components.

As shown in FIG. 5E, at block 571, the system 10 is configured to perform a lookup from a historical journey database 518, for example stored in warehouse storage 517, of a historical average processing time for each historical journey trace having a same historical grid cell including the same determined time period as a journey start grid cell. For example, the system looks up average historical processing times for journey traces having the same historical grid cell and the same hour as the journey start grid cell.

As the historical time taken is calculated for both the grid cell of the journey start and the hour, this means that the journey traces will be substantially equally distributed across workers 575a . . . n as described below, as the data is structured for both cell and time. Advantageously, data for periodic journey patterns—for example reflecting people commuting from rural areas to work in the morning and returning in the evening—are optimally distributed across the workers 575a . . . n. The distribution also advantageously and efficiently processes for velocity of data impacted by long term trends in driving behavior.

At block 572, the system is configured to calculate a geohash of a center of the journey start grid cell. At block 573, the system is configured to order the rows of journey hashes of the batch database 518 by the calculated geohashes. Ordering the journeys by geohashes of the start cell ensures that journeys in the same geographical area are likely to be processed on the same worker 575n module, as described below. The geographical co-location of processed journeys on the same worker takes advantage of the insight that journeys starting at the same time in the same geographical area tend to have similar drive times. In an embodiment, the road segments for each grid cell loaded on demand. As road segments for each grid cell are only loaded to the worker 575n on demand, this reduces the memory requirement for each worker 575n.

As will be appreciated, partitioning the databases to co-locate journeys from the same geographical area provides significant improvements in computational speed and efficiency by, inter alia, optimally distributing journey trace computation across the workers 575a . . . n such that the total processing time of each partitioned database is substantially equal. Accordingly, in an embodiment the system is configured to allocate the journeys from the database to worker modules 575a . . . n so that the expected processing time for those journeys on each worker is substantially equal. At block 574, the system is configured to partition and allocate the rows of journey traces having substantially the same historical average processing time to a worker module 575n. Accordingly, the system is configured to allocate the partitioned databases 518a, 518b, 518n of journey traces having substantially the same historical average processing time to a plurality of respective worker modules 575a, 575b, 575n. This allocation to the respective worker modules 575a . . . n results in a computation processing time for each worker module 575n that is substantially equal.

For example, because the rows of journey hashes of the batch database 518 are ordered by the calculated geohashes and start cell. Each worker gets a database partitioned by the cell references and the list of rows processed by cell references, where one worker has multiple cells and journeys. As noted above, the processing time for each worker is based on the insight that journeys starting at the same time in the same geographical area tend to have similar drive times. Because the cells are ordered by geohash, the system can then determine how long it takes for the worker to process the entire database, and then partition the database by the number of workers. As noted above, the historical time taken is calculated for both the grid cell of the journey start and the hour. The result is that each worker gets a partition of geographically co-located journeys such that the total processing time of each partitioned database is substantially equal. This means that the journeys will be substantially equally distributed across workers based on periodic journey patterns (e.g.: as people commuting from rural areas to work in the morning and returning in the evening will be optimally distributed) and long term trends in driving behavior.

As will be appreciated, the system does not make subjective determinations. Rather, it is the algorithmic organization of the database as described above that produces technological advance in computational efficiency. Ordering the journeys by geohash ensures that journeys in the same geographical area are likely to be processed on the same worker. Thus, for example on one worker a partition may have a smaller number of geographically co-located journeys from a geographical area that are slower to process, whereas a partition on another worker may have a larger number of geographically co-located journeys from another geographical area that are faster to process. Of course, some journey traces may be outliers, where the processing time is significantly longer than the average for the grid cell, but it was found that the outliers tend to average out.

At block 576, on each worker module 575n, system snaps the journey traces from the respective database assigned to it to roads using the Viterbi trellis algorithm described above with respect to FIG. 5B.

At block 578, the system then stores a time taken to process each of the journey start grid cells in the historical journey database 518 in warehouse 517 for later lookup of the processing time as described at block 571.

In an embodiment, the system is configured to run the process described above at predetermined time intervals. At block 580, the system is configured to cache road segments in cache memory on each of a plurality of worker modules 575a . . . n between the time intervals. For example, road segments for grid cells are cached on each worker module 575n between each hourly run of the process. As each worker module 575n is generally assigned the same geographical area, on subsequent runs of the process, most of the road segments will already be loaded into cache memory.

The system can be configured to geospatially partition both the data to be snapped and the road segments data for efficient horizontal scaling using the following algorithm.

$${T}_{G} : ( - 180 , 180 ) * ( - 90 , 90 ) \to {R}^{2} \\ {T}_{G} ( long , lat ) = ( {K}_{x} long , {K}_{y} lat ) \\ {K}_{x} = \frac{R cos {G}_{y}}{{( 1 - {e}^{2} {sin}^{2} {G}_{y} )}^{\frac{1}{2}}} , {K}_{y} = \frac{R ( 1 - {e}^{2} )}{{( 1 - {e}^{2} {sin}^{2} {G}_{y} )}^{\frac{3}{2}}}$$

wherein R is earth's equatorial radius and e is an eccentricity of a WGS84 ellipsoid.

As will be appreciated, the constants Kₓ and K_{y} depend only on the latitude of the center of the grid. These constants capture the difference in scale in degrees of longitude and latitude at this point.

At the scale of the typical distances being computing (<200 m), the difference in distance calculations compared to the Vincenty formulas for an World Geodetic System WGS84 ellipsoid model of the earth are negligible across an entire grid cell, and similarly for calculations involving angles. It was determined that the distance calculations are generally more accurate than using a spherical haversine approximation even though they are trivial to compute in comparison.

Accordingly, it was determined that by using these grid cell projections and working in general with squared distances, the system 10 is able to compute and complete the majority of its computations with just basic arithmetical operators. This results in highly advantageous efficiency in computational power and memory of the more computationally extensive algorithms, such as the spherical haversine approximation.

In an embodiment, the system can be configured to employ the point-snapping and a journey segmentation analysis as described above to advantageously perform automated identification of turn counts at intersections. In an embodiment, a map-matched journey segment can include a short section of road, where at either end there is either an intersection or a dead end.

The raw point data is first passed through the journey segmentation and aggregation process, for example as described with respect to FIGS. 5A-5E, to obtain a journey trace for a full journey at 3 second intervals.

This journey trace is then input into the journey snapping algorithm. Various embodiments of journey segments for journeys as described with respect, inter alia, to FIGS. 5A-5E are identified for journeys. This provides, for each individual journey, a full list of journey segments which are traversed during the journey, along with a time the segment was first entered. As will be appreciated, the system can be configured to infer journey segments for a vehicle's journey when the system does not ingress or is missing a data point for that vehicle. Because the system is configured to identify end-to-end journeys for vehicles, the system can be configured to infer segment from a full journey path of the vehicle by identifying missing segments or data points of the journey.

As noted above, a consecutive pair of journey segments in a journey trace can describe a transition through an intersection. For a consecutive pair of journey segments describing such a transition, the first segment describes the path into the intersection and the second segment describes the path out of the intersection. Each journey trace can then be divided into consecutive pairs of segments. The system can be configured to count how many times each pairing occurs in a given time frame. The system thereby provides a count of how many of each type of transition is made through a given intersection on a per vehicle basis. The system can then group the transition types by intersection to get the turn ratios for each different transition through an intersection.

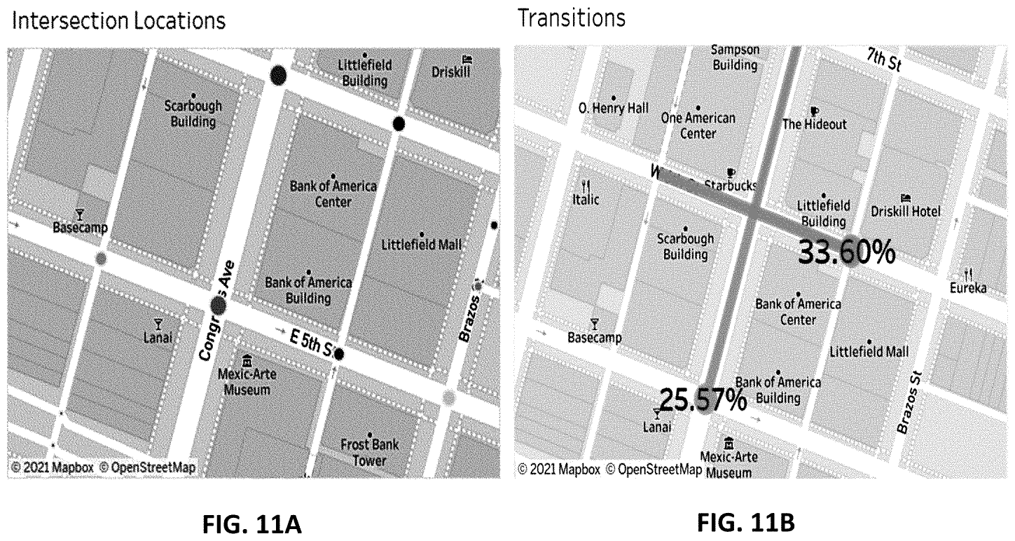

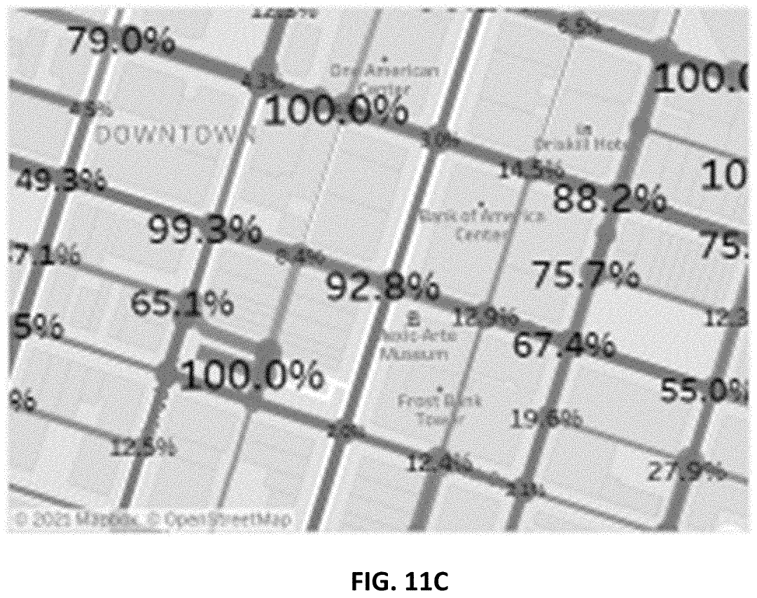

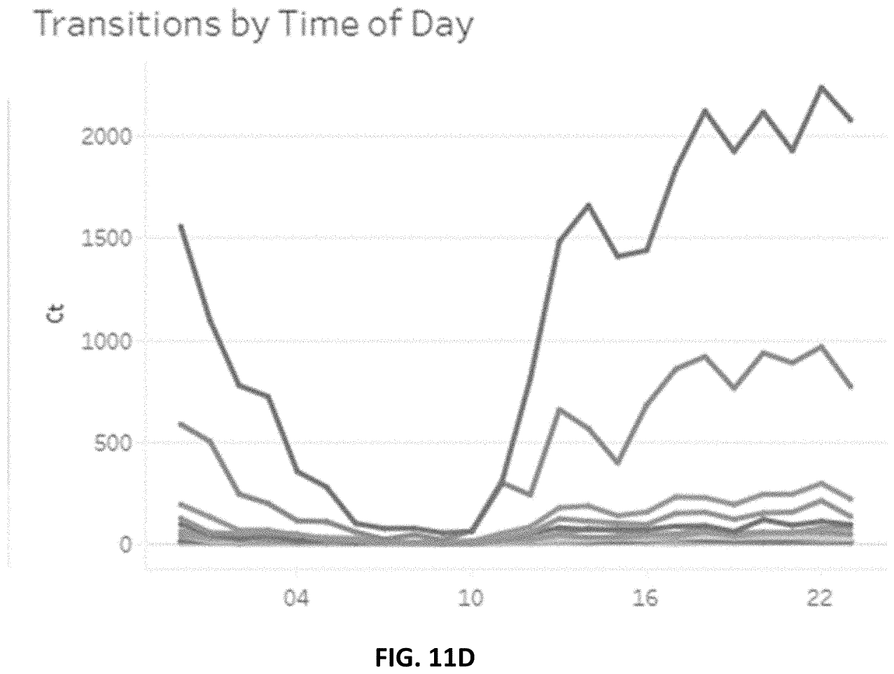

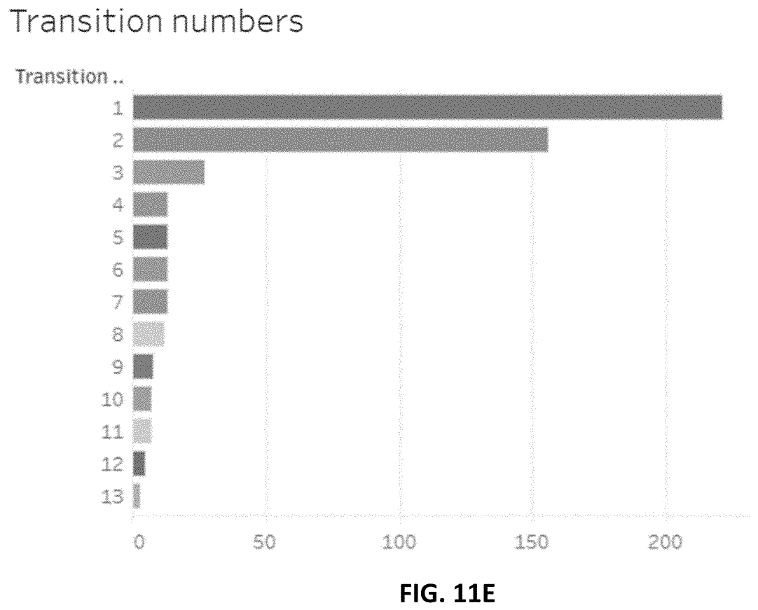

For example, as shown on the mapping interfaces of FIGS. 11A-11B, the system is configured to calculate turn count ratios at intersections. As shown in FIG. 11A, intersections having vehicle event data are identified. Once journey analysis is performed and paired journey segments for vehicle journeys are determined, the system can then calculate turn ratios and types. For example, as shown in FIG. 11B, at given intersection, the system can identify percentage of vehicles are travelling straight through the intersection and what percentage are making a left or right turn through the intersection. As shown in FIG. 11C, the system can perform this analysis for an entire geographical location for which it has performed journey analysis. Such identifications are advantageous, for example, in assessing vehicle movements intersections with one-way turns (e.g. numbers and percentages of illegal turns).

As shown in FIG. 11D the system can also identify turn count ratios and types for all transitions through a given intersection over a 24 hour period. This can be advantageously employed to, inter alia, apportion percentages to help understand which the commonly traversed direction for that intersection at specific times.

An intersection can have many types of turns. For example, at a 4 way intersection of two streets, a vehicle can, for each of the 4 incoming roads, go straight through or turn left or right. As will be appreciated, types of turns are identified and counted by journey analysis of the data itself. As shown in FIG. 11E, a given intersection has 13 possible permutations to it. The top 2 most commonly travelled directions are straight ahead in both directions.

As will be appreciated, the system can be configured to count turns and turn ratios using mass vehicle event data, including historical data going back years, with no implementation of hardware or personnel on road networks as is conventionally done. For example, the system as described includes vehicle event data going back at least two years covering 95% of US road networks.

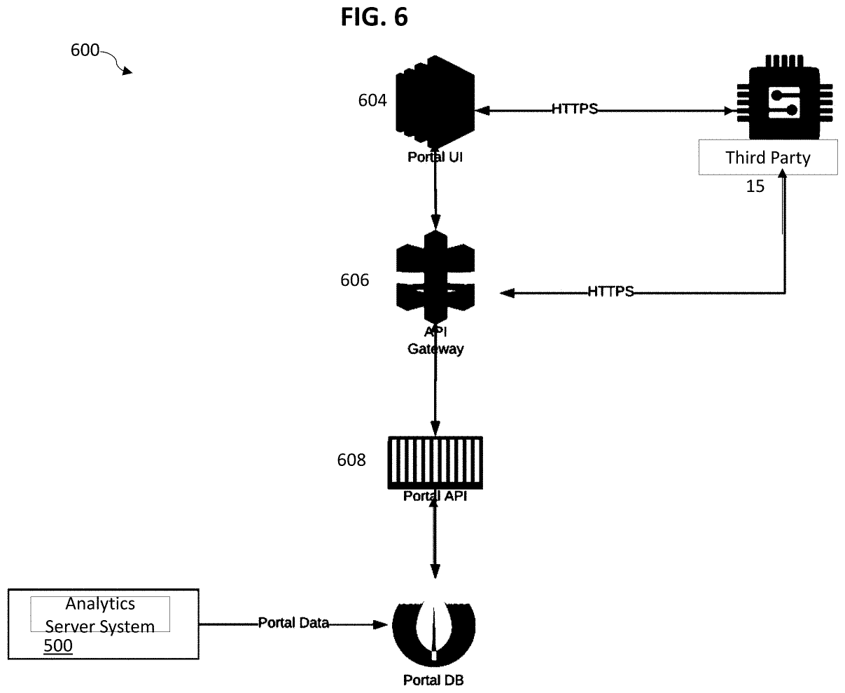

FIG. 6 is a logical architecture for a Portal Server system 600. In at least one embodiment, Portal Server system 600 can be one or more computers arranged to ingest and throughput records and event data. The Portal Server system 600 can be configured with a Portal User Interface 604 and API Gateway 606 for a Portal API 608 to interface and accept data from third party 15 users of the platform. In an embodiment, the Portal Server system 600 can be configured to provide daily static aggregates and is configured with search engine and access portals for real time access of data provided by the Analytics Server system 500. In at least one embodiment, Portal Server system 600 can be configured to provide a Dashboard to users, for example, to third party 15 client computers. In at least one embodiment, information from Analytics Server system 500 can flow to a report or interface generator provided by a Portal User interface 604. In at least one embodiment, a report or interface generator can be arranged to generate one or more reports based on the performance information. In at least one embodiment, reports can be determined and formatted based on one or more report templates.

The low latency provides a super-fast connection delivering information from vehicle source to end-user customer. Further data capture has a high capture rate of 3 seconds per data point, capturing up to, for example, 330 billion data points per month. As described herein, data is precise to lane-level with location data and 95% accurate to within a 3-meter radius, the size of a typical car.

FIG. 7 is a flow chart showing a data pipeline of data processing as described above. As shown in FIG. 7, in an embodiment, event data passes data through a seven (7) stage pipeline of data quality checks. In addition, data processes are carried out employing both stream processing and batch processing. Streaming operates on a record at a time and does not hold context of any previous records for a trip, and can be employed for checks carried out at the Attribute and record level. Batch processing can take a more complete view of the data and can encompass the full end-to-end process. Batch processing undertakes the same checks as streaming plus checks that are carried out across multiple records and Journeys.

In at least one embodiment, a dashboard display can render a display of the information produced by the other components of the system 10. In at least one embodiment, dashboard display can be presented on a client computer accessed over network. In at least one embodiment, user interfaces can be employed without departing from the spirit and/or scope of the claimed subject matter. Such user interfaces can have any number of user interface elements, which can be arranged in various ways. In some embodiments, user interfaces can be generated using web pages, mobile applications, GIS visualization tools, mapping interfaces, emails, file servers, PDF documents, text messages, or the like. In at least one embodiment, Ingress Server system 100, Stream Processing Server system 200, Egress Server system 400, Analytics Server system 500, or Portal Server system 600 can include processes and/or API's for generating user interfaces.

For example, as shown in the flow chart 800 of FIG. 8, feed data can be combined into an aggregated data set and visualized using an interface 802, for example a GIS visualization tool (e.g.: Mapbox, CARTO, ArcGIS, or Google Maps API) or other interfaces. In an embodiment, the system configured to provide connected vehicle (CV) insights and traffic products interfaces 802 therefor is described with respect to exemplary data processing of CV event data and segment event as described herein. An interface can also be configured to output data via interfaces to downstream devices such as traffic management devices, for example, via the Egress Server or Portal Sever. As shown in FIG. 8, the data feeds can include exemplary feeds such as, for example data set 804, data set 806, and connected vehicle movement data or segment event data 806.

Embodiments described with respect to systems 10, 50, 100, 200, 400, 500, 600, 700, and 800 are described in conjunction with FIGS. 1A-8, can be implemented by and/or executed on a single network computer. In other embodiments, these processes or portions of these processes can be implemented by and/or executed on a plurality of network computers. Likewise, in at least one embodiment, processes described with respect to systems 10, 50, 100, 200, 400, 500, 600, 700, and 800 or portions thereof, can be operative on one or more various combinations of network computers, client computers, virtual machines, or the like can be utilized. Further, in at least one embodiment, the processes described in conjunction with FIGS. 1A-9 can be operative in system with logical architectures such as those also described in conjunction with FIGS. 1A-9.

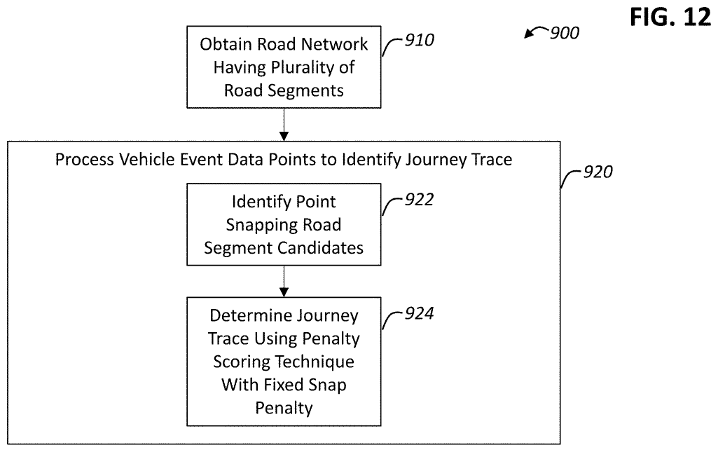

With reference to FIG. 12, there is shown a method 900 of determining a journey trace for a plurality of vehicle event data points. The method 900 begins with step 910, wherein a road network having a plurality of road segments is obtained. The road network may be represented by any suitable representation of a road network or a plurality of roads and their interconnections, such as through use of a multigraph as discussed above. The method 900 proceeds to step 920.

In step 920, vehicle event data points of a vehicle are processed to identify a journey trace. According to at least some embodiments, this step includes sub-steps 922-924. In step 922, one or more (and, in some embodiments, a plurality of) point snapping road segment candidates for one or more of the vehicle event data points is identified. The method 900 proceeds to step 924.

In step 924, a journey trace is determined based on identifying the journey trace having a lowest overall penalty among a plurality of candidate journey traces. The journey trace includes an ordered set of a plurality of the road segments defining a path taken by the vehicle, where at least one road segment in the ordered set is obtained from the point snapping candidate(s).

In the present embodiment of the method 900, an overall penalty for the journey trace is determined using a penalty scoring technique where, for each of the one or more vehicle event data points, a fixed snap candidate having a fixed snap penalty is included as one of the one or more point snapping road segment candidates. As discussed above, at least in some embodiments, the penalty scoring technique may determine a penalty for point snapping a road segment candidate to a vehicle event data point (a “point snapping penalty”) and this point snapping penalty may be based on a distance between the road segment candidate and a location of the vehicle event data point, such as the location indicated by the longitude and latitude of the vehicle event data point. A distance may be determined between the vehicle event data point and each of the plurality of point snapping road segment candidates (which may be associated with a representative geographical location indicated by, for example, a longitude and latitude) and this distance may be used to determine the point snapping penalty. However, as mentioned above, according to embodiments, the plurality of point snapping road segment candidates may include a fixed snap candidate having a fixed snap penalty. Therefore, the plurality of point snapping road segment candidates includes point snapping road segment candidates as well as a single fixed snap candidate, at least according to one embodiment. In some embodiments, each of the vehicle event data points may have a fixed snap candidate as a part of the one or more point snapping road segment candidates and, in some embodiments, only a subset of the vehicle event data points may have a fixed snap candidate as a part of the one or more point snapping road segment candidates. In step 920, the journey trace may be determined using the “most likely” path methodology described above, which may use the Viterbi trellis technique. The method 900 then ends.

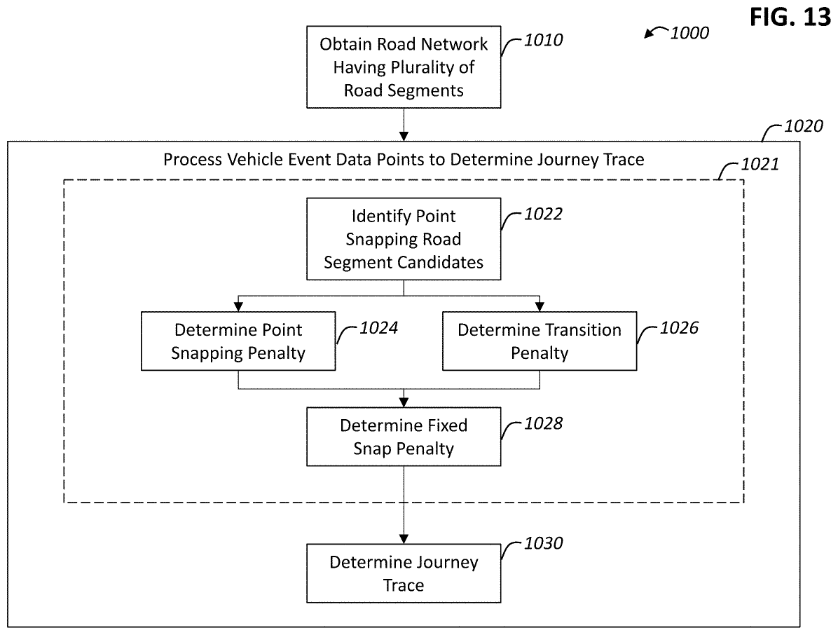

With reference to FIG. 13, there is shown a method 1000 of determining a journey trace for a plurality of vehicle event data points. The method 1000 begins with step 1010, wherein a road network having a plurality of road segments is obtained. The road network may be represented by any suitable representation of a road network or a plurality of roads and their interconnections, such as through use of a multigraph as discussed above. The method 1000 proceeds to step 1020.

In step 1020, a plurality of vehicle event data points are processed so as to determine a journey trace. In the illustrated embodiment, the step 1020 includes sub-steps 1022-1028 and begins at step 1022. Steps 1022-1028, which may be described as a vehicle event data penalty determining process 1021, apply to each of the plurality of vehicle event data points and may be carried out for each of the plurality of vehicle event data points. In step 1022, a non-fixed set of point snapping road segment candidates is determined for a given vehicle event data point. This may be determined using the techniques described above, such as those employing a point snapping bounding radius. In step 1024, for each of the non-fixed set of point snapping road segment candidates, a point snapping penalty is determined. In step 1026, for each of the non-fixed set of point snapping road segment candidates, a transition penalty is determined. Therefore, for each of the non-fixed set of point snapping road segment candidates (say, for example, there are M number) for each of the plurality of vehicle event data points (say, for example, there are N number), a point snapping penalty and a transition penalty are determined so that there are N×M point snapping penalties and N×M transition penalties.

In step 1028, a fixed penalty, such as a fixed point snapping penalty and/or a fixed transition penalty, is included in a set of point snapping road segment candidates that includes the non-fixed set of point snapping road segment candidates. Therefore, in embodiments, the set of point snapping road segment candidates includes the non-fixed set of point snapping road segment candidates and the fixed snap candidate. Thus, each vehicle event data point may be associated with M+1 point snapping road segment candidates when including/counting the fixed snap candidate. The method 1000 continues to sub-step 1030.

In step 1030, a journey trace is determined by determining the journey trace that having a lowest overall penalty among a plurality of candidate or potential candidate journey traces (referred to as candidate journey traces). This may be carried out using the Viterbi trellis-based method discussed above. The method 1000 then ends.

It should be appreciated that the method 900 and the method 1000 described embodiments that overlap in nature and are not meant to be mutually exclusive of one another. Indeed, many embodiments according to the present disclosure are within the scope of both the method 900 and the method 1000 as described above.

According to some embodiments and implementations, the methods 900 and/or 1000 be used to provide more accurate journey trace determinations by introducing the fixed snap feature described above. It has been discovered that, in some scenarios, when determining a journey trace using a “most likely” path finding technique and/or using road segments to which locations are snapped such as according to the discussion above, instances of loitering may cause inaccurate and/or seemingly uncharacteristic journey traces. Thus, the fixed snap candidate may be introduced to represent loitering instances and, according to at least some embodiments, the fixed snap penalty includes a fixed point snapping penalty and a fixed transition penalty; in a particular embodiment and according to some scenarios and implementations, it has been discovered that a high fixed point snapping penalty and a low fixed transition penalty result in preferable results since such penalties have been discovered to be accurate placeholder/representative values for certain behaviors, such as loitering (e.g., loitering in a parking lot or off-road). A high penalty refers to penalties that have a value that is higher than one half of a max point snapping penalty when considering the other like penalties-thus, a high point snapping penalty is a point snapping penalty that is higher than the mean of point snapping penalties for the point snapping road segment candidates. A penalty that is not a high penalty is a low penalty. Accordingly, a high fixed point snapping penalty is a fixed point snapping penalty that is higher in value that the half of the max point snapping penalty. In one particular embodiment, for example, the fixed point snapping penalty is set to the max point snapping penalty and the fixed transition penalty is set to zero (of zero magnitude).

As discussed above, in embodiments, the journey trace is identified as having an ordered list of the plurality of road segments which minimizes a sum of all the penalized square distances of each of the selected road segments along with a sum of all the transition penalties between consecutive segments. In at least some embodiments, the fixed snap penalty includes using a fixed point snapping penalty in place of the penalized square distances (or road segment distance penalty) and/or using a fixed transition penalty in place of the transition penalty described above.

According to at least some embodiments, the method 900 and/or the method 1000 may be used to assign fixed or predetermined penalties, or reduced penalties, to vehicle event data points corresponding to instances where a vehicle is loitering off-road and/or alongside a road, such as for purposes of waiting for and/or picking up a passenger. In such instances, assigning a road segment and corresponding penalty to these vehicle event data points may result in unexpected outputs (e.g., overall penalties) and/or may be unnecessary from a computing perspective at least in some scenarios and according to some embodiments. Thus, according to some embodiments, a fixed snap candidate may be included as a potential candidate for each of the vehicle event data points so that unexpected results are less frequent and/or computational resources are better utilized.

It will be understood that each block of the flowchart illustration, and combinations of blocks in the flowchart illustration, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the disclosure.

Accordingly, blocks of the flowchart illustration support combinations for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments.

1. A system comprising an electronic processor and a memory accessible by the processor, wherein the processor is configured to execute program instructions stored on the memory for a method comprising:
obtaining a road network having a plurality of road segments; and
processing a plurality of vehicle event data points of a vehicle to identify a journey trace, each vehicle event data point comprising a longitude, a latitude, and a captured timestamp, wherein the processing comprises:
identifying one or more point snapping road segment candidates for one or more of the plurality of vehicle event data points; and
determining a journey trace based on identifying the journey trace having a lowest overall penalty among a plurality of candidate journey traces, wherein the journey trace includes an ordered set of a plurality of the road segments defining a path taken by the vehicle, wherein the plurality of the road segments is obtained from the one or more point snapping candidates, and wherein an overall penalty of the journey trace is determined using a penalty scoring technique where, for each of the one or more vehicle event data points, a fixed snap candidate having a fixed snap penalty is included as one of the one or more point snapping road segment candidates.

2. The system of claim 1, wherein the fixed snap penalty is a predetermined penalty that is of a fixed magnitude.

3. The system of claim 1, wherein the fixed snap penalty includes a fixed point snapping penalty that is greater than point snapping penalties used for other ones of the one or more point snapping road segment candidates.

4. The system of claim 1, wherein the fixed snap penalty is set to be equal to a max point snapping penalty that is determined based on a point snapping penalty function and a predetermined point snapping bounding radius.

5. The system of claim 1, wherein the fixed snap penalty includes a fixed transition penalty that is determined differently than a transition penalty that is determined for a transition without a fixed snap candidate.

6. The system of claim 5, wherein the fixed transition penalty is zero.

7. The system of claim 5, wherein fixed snap penalty further includes a fixed point snapping penalty that is a high fixed point snapping penalty.

8. The system of claim 1, wherein a point snapping distance penalty function is used to determine a snapping penalty for at least one point snapping road segment that is not a fixed snap candidate, and wherein the point snapping distance penalty function, for a given vehicle event data point and give road segment candidate, is based on a distance between the given vehicle event data point and the give road segment candidate.

9. The system of claim 1, wherein, for each of the one or more vehicle event data points, a plurality of point snapping road segment candidates are identified such that the plurality of point snapping road segment candidates includes a single fixed snap candidate.

10. A method of determining a journey trace for a plurality of vehicle event data points, wherein the method comprises:
obtaining a road network having a plurality of road segments; and
processing vehicle event data points of a vehicle to identify a journey trace, each vehicle event data point comprising a longitude, a latitude, and a captured timestamp, wherein the processing comprises:
identifying one or more point snapping road segment candidates for one or more of the vehicle event data points; and
determining a journey trace based on identifying the journey trace having a lowest overall penalty among a plurality of candidate journey traces, wherein the journey trace includes an ordered set of a plurality of the road segments defining a path taken by the vehicle, wherein the plurality of the road segments is obtained from the one or more point snapping candidates, and wherein an overall penalty of the journey trace is determined using a penalty scoring technique where, for each of the one or more vehicle event data points, a fixed snap candidate having a fixed snap penalty is included as one of the one or more point snapping road segment candidates.

11. The method of claim 10, wherein the fixed snap penalty is a predetermined penalty that is of a fixed magnitude.

12. The method of claim 10, wherein the fixed snap penalty includes a fixed point snapping penalty that is greater than point snapping penalties used for other ones of the one or more point snapping road segment candidates.

13. The method of claim 10, wherein the fixed snap penalty is set to be equal to a max point snapping penalty that is determined based on a point snapping penalty function and a predetermined point snapping bounding radius.

14. The method of claim 10, wherein the fixed snap penalty includes a fixed transition penalty that is determined differently than a transition penalty that is determined for a transition without a fixed snap candidate.

15. The method of claim 14, wherein the fixed transition penalty is zero.

16. The method of claim 14, wherein fixed snap penalty further includes a fixed point snapping penalty that is a high fixed point snapping penalty.

17. The method of claim 10, wherein a point snapping distance penalty function is used to determine a snapping penalty for at least one point snapping road segment that is not a fixed snap candidate, and wherein the point snapping distance penalty function, for a given vehicle event data point and give road segment candidate, is based on a distance between the given vehicle event data point and the give road segment candidate.

18. The method of claim 10, wherein, for each of the one or more vehicle event data points, a plurality of point snapping road segment candidates are identified such that the plurality of point snapping road segment candidates includes a single fixed snap candidate.

19. The method of claim 10, wherein the method is performed by a computer system having at least one processor and memory storing computer instructions, and wherein, when the at least one processor executes the computer instructions, the computer system performs the method.

20. A method of determining a journey trace for a plurality of vehicle event data points, wherein the method comprises:
obtaining a road network having a plurality of road segments; and
processing a plurality of vehicle event data points of a vehicle to determine a journey trace, each vehicle event data point comprising a longitude, a latitude, and a captured timestamp, wherein the processing comprises:
for each of the plurality of vehicle event data points, carrying out a vehicle event data penalty determining process that includes:
determining a non-fixed set of point snapping road segment candidates for the vehicle event data point;
determining a point snapping penalty for each point snapping road segment candidate of the non-fixed set of point snapping road segment candidates; and
determining a fixed snap candidate associated with a fixed snap penalty; and
determining the journey trace as the journey trace having a lowest overall penalty determined based on a penalty scoring technique that uses the fixed snap penalty and the point snapping penalty.
